(19) United States
(12) Patent Application Publication
(10) Pub. No.: US 2004/0239593 A1
(43) Pub. Date: Dec. 2, 2004

(54) Plasma display panel drive method and plasma display panel driver

(76) Inventor: Kazuhiro Yamada, Takatsuki-shi (JP)

Correspondence Address: Joseph W Price, Snell & Wilmer, Suite 1200, 1920 Main Street, Irvine, CA, 92614-7230, US

(21) Appl. No.: 10/482,899

(22) PCT Filed: Jul. 8, 2002
(86) PCT No.: PCT/JP02/06915

(30) Foreign Application Priority Data
Jul. 9, 2001 (JP) 2001-207488

(51) Int. Cl. G09G 3/28

(52) U.S. Cl. 345/63

(57) ABSTRACT

A plasma display panel drive method for performing gradation display by selecting a subfield from a plurality of subfields gained by time-sharing a field according to a luminance level of an input image signal, performing write in the selected subfield by applying a voltage to cells, and causing cells to perform sustained light emission in the subfield corresponding to a result of the write, wherein the field includes two or more first subfield groups and one or more second subfield groups (arranged in a predetermined order), each first subfield group is set so that a state of one of extinction and light emission is sustained until before a first write is performed, and the opposite of the state before the first write is maintained after the first write is performed, and each second subfield group is set so that the state of one of extinction and light emission is only changed to the opposite state if write is performed.

### FIELD OF THE INVENTION

The present invention relates to a drive method and drive device of a plasma display panel used in display devices for information terminal apparatuses, computers and the like, and television image display devices.

### BACKGROUND ART

Recently, among display devices being used in computers and televisions and the like, plasma display panels are attracting some attention as display devices which can be realized in large sizes having light weights and slim shapes.

These plasma display panels are display devices that realize color display by applying ultraviolet light, generated by plasma discharge in gas, to phosphor (red, green and blue).

In a plasma display panel drive device which drives such a plasma display panel, one field of image is time-shared between a plurality of sub-fields. The plasma display panel driving device performs gradation display by controlling a number of discharges for each sub-field.

FIG. 1 shows an electrode configuration of an ordinary plasma display panel 100, and three driving circuits for performing gradation display in the plasma display panel, that is, a data driver 200, a scan driver 220 and a sustain driver 210.

The plasma display panel 100 has a plurality of scan electrodes 101 and a plurality of sustain electrodes 102 which are arranged on a front glass substrate (which is not shown in the drawing), and a plurality of data electrodes 103 which are arranged on a back glass substrate which faces the front substrate (which is also not shown).

The data driver 200 and the scan driver 220 selectively apply voltages to the pluralities of data electrodes 103 and scan electrodes 101 respectively, and the sustain driver 210 applies a voltage to all of the plurality of sustain electrodes 102 at once.

The scan electrodes 101 and sustain electrodes 102 are arranged parallel to each other, and the data electrodes 103 are arranged so as to be perpendicular to the scan electrodes and sustain electrodes.

The vicinity between two points at which an electrode pair being of a scan electrode 101 and a sustain electrode 102 intersects with a data electrode 103 is a cell 104, which is the smallest unit of display.

Below is a basic explanation of a drive method that drives a plasma display panel, where one field of image is time-shared between a plurality of sub-fields.

FIG. 2 shows a voltage waveform that is applied to the scan electrodes 101, the sustain electrodes 102, and the data electrodes 103 according to an ordinary plasma display panel drive method.

The procedure of voltage application within one sub-field is explained below.

First of all, charges that are accumulated in dielectric layers covering the electrodes, are erased by an erase pulse 301 that is applied to the sustain electrodes 102 (erase process).

Here, within a subfield, a period in which the erase process is performed is called an erase period.

Next, a high voltage initialization pulse 302 is applied to the scan electrodes 101, discharge is generated in all the cells of the panel (hereinafter called “initialization discharge”), a negative charge accumulates in the dielectric layer covering the scan electrodes 101, and a positive charge accumulates in the dielectric layer covering the data electrodes 103 (initialization process).

Here, within a subfield, a period in which the initialization process is performed is called an initialization period.

Note that immediately after the initialization period is performed, because a space charge has been formed equally in all the surfaces within the cell by the initialization discharge, the formed space charge becomes the source of the next write discharge, thus simplifying the generation of write discharge.

Further, according to the execution of the initialization process, the charges accumulated on the dielectric layer covering the scan electrodes 101 and the dielectric layer covering the data electrodes 103 work effectively, and the amplitudes of the scan pulses and data pulses can be lowered.

Subsequently, the application of a positive data pulse 304 to a data electrode 103, during which a negative scan pulse 303 is applied to a scan electrode 101, causes the generation of the write discharge within the cell which exists at the intersecting point between the scan electrode and the data electrode 103.

Note that the application of the data pulse 304 to the data electrode 103 is selectively performed based on an image signal obtained from an external source.

At this time, a positive sustain write pulse 306 is also applied to the sustain electrode 102, which causes, in the case of write discharge, a positive charge to accumulate in the dielectric layer covering the scan electrode 101, and a negative charge to accumulate on the dielectric layer covering the sustain electrode (write process).

Here, within a sub-field, a period in which the write process is performed is called a write period.

When a write period ends incompletely, there are cases where a discharge cell which should emit light in the next sustain period does not emit light, and this is called write error.

When write error occurs, picture quality deteriorates because light is not emitted when it should be emitted.

Next, a high voltage sustain pulse 305 is applied alternately to the scan electrode 101 and the sustain electrode 102.

At this time, sustain discharge is generated only in the cells in which write discharge occurred in the write period, that is to say, the cells in which a negative charge was accumulated on the dielectric layer covering the sustain electrode (sustain process).

Here, within a sub-field, a period in which the sustain process is performed is called a sustain period.

The sustain discharge contributes light emission to the image display.

Note that because the sustain period ends having applied a sustain pulse to the scan electrode 101, a positive charge remains accumulated on the sustain electrode 102 after the end of the sustain period.

As shown in FIG. 3, the above sequential voltage applications are performed in all of the subfields which make up a field.

Note that in the drawing, when a field is time-shared between n subfields, the first sub-field is described as SF1, and the following sub-fields are SF2, SF3, to SFn. The sub-fields are also described in this way in the other drawings which follow FIG. 3.

A plasma display panel drive method which has, as described above, an initialization process, writing process, sustain process and erase process in each sub-field, is called an ADS (Address Display period Separated sub-field method) drive method.

The abovementioned ADS drive method is described in Japanese Laid-open Patent Application Publication No. 6-186927 “Display Panel Drive Method and Device” and Japanese Laid-open Patent Application Publication No. 5-307935 “Plasma Display Device”.

If a plasma display panel is driven using this ADS drive method, a weak light emission is generated by the initialization discharge in the initialization period of each sub-field, in which light emission is undesirable. During low gradation display this light emission causes an unnecessary luminance increase, which creates a problem of deterioration in contrast.

The “Method for Driving AC type Plasma Display Panel” described in Japanese Laid-open Patent Application Publication No. 2000-242224 is a method for solving this kind of problem.

This drive method suppresses light emission in periods in which light should not be emitted, and prevents luminance increase during low gradation display, by abolishing the erase process in some of the sub-fields and performing the last sustain pulse of the sustain period and the initialization process of the next subfield simultaneously (in the said subfields), as shown in FIG. 4.

Note that occurrence of the previously mentioned write error becomes likely due to the abolition of the erase process. However improvements (regarding the write error) taking approaches other than a drive method approach, such as improvements in the quality of materials in the dielectric protective layer (the top layer on the front glass substrate) are able to eliminate problems caused by write error, even if the erase process is not performed in some of the sub-fields.

Note that this kind of plasma display panel drive method is called a Real Black drive method, and will be explained as being included in the ADS drive method, so as to be distinguished from an STCE drive method which will be mentioned later.

FIG. 5 shows waveforms of voltages applied to the scan electrode 101, the sustain electrode 102, and the data electrode 103 in the Real Black drive method.

The differences between the Real Black drive method and the ADS drive method are that (a) the base voltage of the voltage applied in the write period in the former method is lower than in the latter method, (b) the electric potential of the scan pulse 313 of the former is lower than that of the scan pulse 303 of the latter, and (c) in the former method part of the sustain period overlaps with the initialization period, and within the overlapping period both an initialization pulse 312 having a continuous step-shaped diminishing voltage, and a sustain pulse 315 having a somewhat reduced voltage are applied.

Incidentally, there is a constant demand for reduction in constant power consumption, since a plasma display panel has a high power consumption when compared with that of a CRT having a screen of the same size.

The “Driving Method of Plasma Display Panel” of Japanese Laid-open Patent Application Publication No. 2000-227778 is a plasma display panel drive method which responds to this demand.

As shown in FIG. 6, in this drive method write is performed in the write process of only one sub-field of a plurality of sequential sub-fields, and an erase period is only provided in the very last sub-field of the plurality of sequential sub-fields in each field.

At this time, up until the sub-field immediately preceding the write sub-field (sub-field in which write is performed), extinction is sustained in the sustain periods, and from the write sub-field onward illumination is sustained in the sustain periods.

In this way, by switching the state of extinction or illumination in the sustain periods before and after the write sub-field, the number of times write is performed is reduced to less than in the ADS drive method, and the power necessary for write, that is to say the power consumed by the write discharge is reduced.

A drive method which continues extinction or illumination in adjacent sustain periods, and switches the state of extinction or illumination by using write as a trigger in this way, without performing write in every sub-field, is called an STCE (Single Triggered Continuous Emission) drive method.

Incidentally, in the STCE drive method, the method in which the write is used as a trigger to start the sustain discharge in the sustain period as mentioned above, is called a selective write method or a positive logic write method, and, on the contrary, the method in which the write is used as a trigger to stop the sustain discharge in the sustain period, wherein the sustain discharge has been continued in the sustain periods from the initialization discharge until the write is performed, is called a selective erase method or negative logic write method.

Below, unless stated otherwise, it is assumed that the driving of a plasma display panel using the STCE drive method is performed based on the selective write method.

FIG. 7 shows a voltage waveform which is applied to the scan electrode 101, the sustain electrode 102, and the data electrode 103.

The differences between the STCE drive method and the ADS drive method are that in sub-field groups to which the STCE drive method is applied, (a) an initialization period, in which an initialization pulse 332 is applied, is provided only in the very first sub-field of the group, therefore there is no initialization period in any of the sub-fields after and including the second sub-field, and (b) the erase process (not shown in the drawing), in which a positive erase pulse having a high voltage is applied to the sustain electrode 102, is provided only in the very last sub-field of the group.

However, despite reducing power consumption, the STCE drive method has a disadvantage in that it has a small number of gradations when compared to an ADS drive method having the same number of sub-fields.

A specific example of this is shown in FIG. 6, where, when one field is time-shared between 12 sub-fields each having different luminance weights, only 13 gradations, being the total of gradations from 0 to 12, can be displayed using the STCE method, since write is either performed in only one of the sub-fields or is not performed at all. Meanwhile, when using the ADS drive method having 12 sub-fields, gradation display having 4096 gradations is possible.

As shown in FIG. 8, there is a method of time-sharing one field between two sub-field groups and applying voltages in each of the sub-field groups according to the abovementioned STCE drive method, which increases the number of gradations in the STCE drive method.

According to this method, the number of times write is performed increases from a maximum of once to a maximum of twice, and although power consumption increases slightly, 4*10=40 gradation is able to be displayed.

There is also another method, of time-sharing one field between 2 sub-field groups, performing voltage applications according to the STCE drive method in one of the sub-field groups, and performing voltage applications according to the ADS drive method in the other sub-field group.

More specifically, if for example the ADS drive method is used in the group of sub-fields consisting of three sub-fields shown in FIG. 8, where the luminance weight in each sub-field varies, and the STCE drive method is used in the other sub-field group, 8*10=80 gradation can be displayed.

However, in such a case, because the number of times write is performed is a maximum of 4, the effect of reduction in power consumption is somewhat lessened.

In this way, in recent years trials of drive methods combining the STCE drive method and the ADS drive method have been conducted in which a plurality of sub-field groups to which the STCE drive method is applied are set within one field.

However, the STCE drive method which has a power consumption reduction effect, and the ADS drive method which has superior gradation display capability, have the following disadvantage.

Basically, being unable to obtain an afterimage effect when viewing a video with a refresh rate of less than 60 frames per second, humans have an inclination to feel a phenomenon wherein a whole screen appears to be flickering (later called “flicker”). This flicker problem is evident in the PAL (Phase Alternation by Line) system video standard which is widely used in Europe, since the image refresh rate is 50 frames per second.

In a case where an image is displayed on a plasma display panel based on a PAL system video signal, a light-emitting sub-field is more easily concentrated into a specific period within a field in the STCE drive method than in the ADS drive method, therefore a light emission luminance peak interval is 1/50 second, the image refresh rate is 50 frames per second, and flicker is likely to occur.

### DISCLOSURE OF THE INVENTION

In consideration of the abovementioned problems, the present invention aims to provide a plasma display panel drive method and a plasma display panel drive device having a low power consumption and maintaining a number of gradations, in which flicker is not likely to occur, even in a case where the image refresh rate (frames/second) is low.

In order to achieve the above aim, the plasma display panel drive method of the present invention is a plasma display panel drive method for performing gradation display by selecting a subfield from a plurality of subfields gained by time-sharing a field according to a luminance level of an input image signal, performing write in the selected subfield by applying a voltage to cells, and causing cells to perform sustained light emission in the subfield corresponding to a result of the write, wherein the field includes two or more first subfield groups and one or more second subfield groups (arranged in a predetermined order), each first subfield group is set so that a state of one of extinction and light emission is sustained until before a first write is performed, and the opposite of the state before the first write is maintained after the first write is performed, and each second subfield group is set so that the state of one of extinction and light emission is only changed to the opposite state if write is performed.

With this structure, since there are two or more first sub-field groups in a field, the period in which light is continuously emitted is divided into two or more periods.

In other words, because luminance emission tends to peak in periods in which light is continuously emitted, a high luminance light emission is performed at least twice in one field.

Accordingly, since an image renewal frequency is at least doubled falsely when there are two or more periods in which light is continuously emitted in a field, the occurrence of flicker is suppressed.

Moreover, in a first subfield group, the power consumption necessary for write is kept lower than in a second subfield group, because it is sufficient in a first subfield group to perform write only once, when the state of light emission or extinction is switched.

Further, the inclusion of a second subfield group in a field can increase a maximum number of gradations per number of subfields in the field, and thus assist in providing a number of gradations which are insufficient when only first subfield groups are included in the field.

Here the first subfield group is an S subfield group (which is described later) to which the STCE drive method is applied, and the second subfield group is an A subfield group (which is also described later) or single subfield to either of which the ADS drive method is applied.

By composing one field from two or more S subfield groups and 1 or more A subfield groups in this way, the occurrence of flicker can be suppressed while maintaining a favorable energy consumption and number of gradations.

Further, the first subfield groups and the second subfield groups may be arranged in an alternating order in the field.

Such alternating enables an arrangement in the field wherein the first subfield groups, in which light is repeatedly emitted, are separated from each other.

That is, when the time interval between luminance peak points in a field is large, the abovementioned effect of the image renewal frequency falsely increasing is more easily obtained.

Further, the field maybe set so that a first subfield group is at a head of the field, and in each first subfield group a state of continuous extinction is sustained until before the first write is performed, and a state of light emission is continued after the first write is performed.

According to this structure, a second subfield group is arranged succeeding a first subfield group.

That is to say, because light emission is concentrated in the end part of the period of light emission in a first subfield group, by arranging a second subfield group adjacent to the end part of a first subfield group in which light emission is concentrated, the light emissions of the first subfield group and the second subfield group are performed back-to-back (continuously), the frequency at which light is emitted in the second subfield group from the start of the extinction state is lowered, and the occurrence of false contour in the vicinity of the abovementioned period is suppressed.

Further, the field may be set so that a second subfield group is at a head of the field, and in each first subfield group a state of continuous light emission is sustained until before the first write is performed, and a state of extinction is continued after the first write is performed.

According to this structure, another first subfield group is arranged succeeding the second subfield group.

That is to say, because light emission is concentrated in the first part of a first subfield group, by arranging a second subfield group adjacent to the first part of the first subfield group in which light emission is concentrated, the light emissions of the second subfield group and the first subfield group are performed continuously, the frequency at which light is extinguished after the light emission in the second subfield group is lowered, and the occurrence of false contour in the vicinity of the abovementioned period is suppressed.

Further, in the plasma display panel drive method, an erase step of erasing a wall charge in all of the cells may be provided in the final subfield of each first subfield group.

With this structure, reliability of the write is improved due to an erasure of the wall charge in the subfield immediately following the first subfield group.

Further, in the plasma display panel drive method, an erase step of erasing the wall charge in all of the cells may be provided in all of the subfields belonging to the second subfield groups.

With this structure, the reliability of write is improved due to the erasure of the wall charge in the subfields within the second subfield group.

Further, in the plasma display panel drive method, an erase step of erasing the wall charge in all of the cells may be provided in a final subfield of the first subfield group, and in a final subfield of each of the second subfield groups.

With this method, the reliability of the write is improved due to the erasure of the wall charge in the subfields immediately succeeding the first and second subfield groups.

Further, in the plasma display panel drive method, an initialization step of applying an initialization pulse in advance to cause initialization discharge in all of the cells at once, thereby forming a wall charge, may be provided in a subfield immediately succeeding the first subfield group, partly parallel to a sustain step provided in a last subfield of the first subfield group.

According to this method, light emission caused by initialization, which is undesirable, is not noticeable, and unnecessary luminance increase is suppressed in low gradation display, because of the performance of the initialization step for the subfield succeeding the first subfield group during the performance of the sustain step in the first subfield group.

Further, in the plasma display panel drive method, an initialization step of applying, in advance, an initialization pulse to cause an initialization discharge in all of the cells at once and thereby form a wall charge, may be performed in a latter of two adjacent subfields within a second subfield group, partly parallel to a sustain step provided in a former of the two adjacent subfields.

According to this method, light emission caused by initialization, which is undesirable, is not noticeable, and unnecessary luminance increase is suppressed in low gradation display, because of the performance of the initialization steps for the subfields succeeding the second subfield groups during the performance of the sustain steps for all of the subfields belonging to the second subfield groups.

Further, in the plasma display panel drive method, an initialization step of applying an initialization pulse to cause an initialization discharge in all of the cells at once and thereby form the wall charge is provided in each subfield that immediately succeeds a subfield in which erase is performed.

Write reliability is improved according to this method.

Further, in the plasma display panel drive method, an initialization step of applying an initialization pulse to cause an initialization discharge in all of the cells at once and thereby form a wall charge is provided in a subfield at a head of the field only.

According to this method, unnecessary luminance increase is suppressed in low gradation display because the initialization step is performed only once in a field.

Further, the plasma display panel drive method may include an initialization step of applying an initialization pulse to cause the uniform initialization discharge in all of the cells and thereby form a wall charge, the initialization pulse being provided only at a head of a first or second subfield group at a head of the field and a first or second subfield group at a middle part of the field.

According to this method, write reliability is improved in subfields positioned at the head or in the middle part of the field.

Further, in the plasma display panel drive method, an initialization step of applying an initialization pulse to cause an initialization discharge in all of the cells at once and thereby form a wall charge may be provided in a head subfield of the first subfield group.

According to this method, write reliability is improved in the subfields within the first subfield groups.

Further, in the plasma display panel drive method, an initialization step of applying an initialization pulse to cause an initialization discharge in all of the cells at once and thereby form a wall charge, may be provided in head subfields of first and second subfield groups.

According to this method, a further improvement is made in write reliability in the subfields within the first subfield groups.

Further, the plasma display panel drive method may be performed in such a way that the initialization discharge is performed in the initialization step in a first subfield group only when a subfield group immediately preceding the first subfield group is not a second subfield group.

According to this method, unnecessary luminance increase is suppressed in low gradation display due to suppression of the number of times the initialization step is performed.

Further, in the plasma display panel drive method, an initialization step of applying an initialization pulse may be provided in all of the subfields of each second subfield group.

According to this method, write reliability is improved in all of the subfields in the second subfield group.

Further, in order to achieve the previously mentioned aim, the plasma display panel drive device of the present invention is a plasma display panel drive device which uses any of the abovementioned plasma display panel drive methods.

Accordingly, since there are two or more first sub-field groups in a field, the period in which light is continuously emitted is divided into two or more periods.

In other words, because luminance emission tends to peak in periods in which light is continuously emitted, a high luminance light emission is performed at least twice in one field.

Accordingly, since the image renewal frequency is at least doubled falsely when there are two or more periods in which light is continuously emitted in a field, the occurrence of flicker is suppressed.

However in a first subfield group, the power consumption necessary for write is kept lower than in the second subfield group, because it is sufficient in a first subfield group to perform write only once, when the state of light emission or extinction is switched.

Further, the inclusion of a second subfield group in a field can increase the maximum number of gradations per number of subfields in the field, and thus assist in providing a number of gradations which are insufficient when only first subfield groups are included in the field.

Here the first subfield group is an S subfield group to which the STCE drive method is applied, and the second subfield group is an A subfield group or a single subfield to either of which the ADS drive method is applied.

By composing one field from two or more S subfield groups and 1 or more A subfield groups in this way, the occurrence of flicker can be suppressed while maintaining a favorable energy consumption ratio and number of gradations.

### BRIEF DESCRIPTION OF THE DRAWINGS

FIG. 1 shows an electrode arrangement of an ordinary plasma display panel, and three drive circuits for performing gradation display in the plasma display panel;

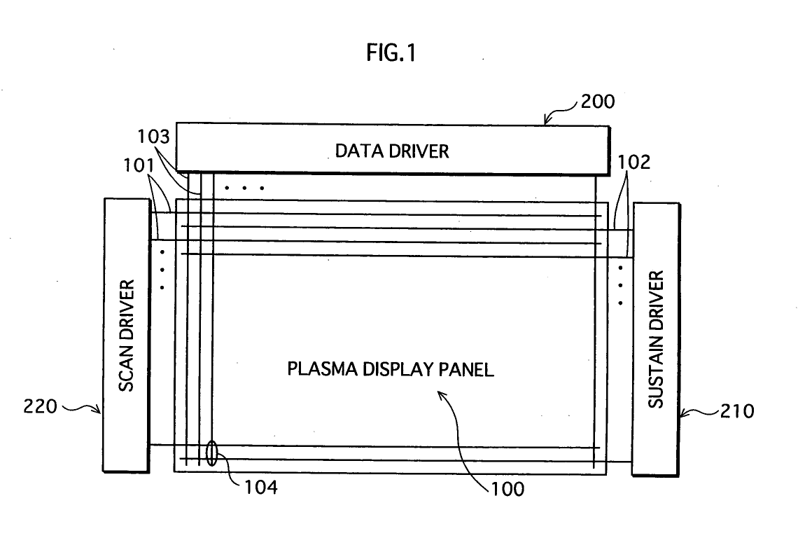

FIG. 2 shows voltage waveforms applied to scan electrodes, sustain electrodes and data electrodes in an ordinary plasma display panel drive method;

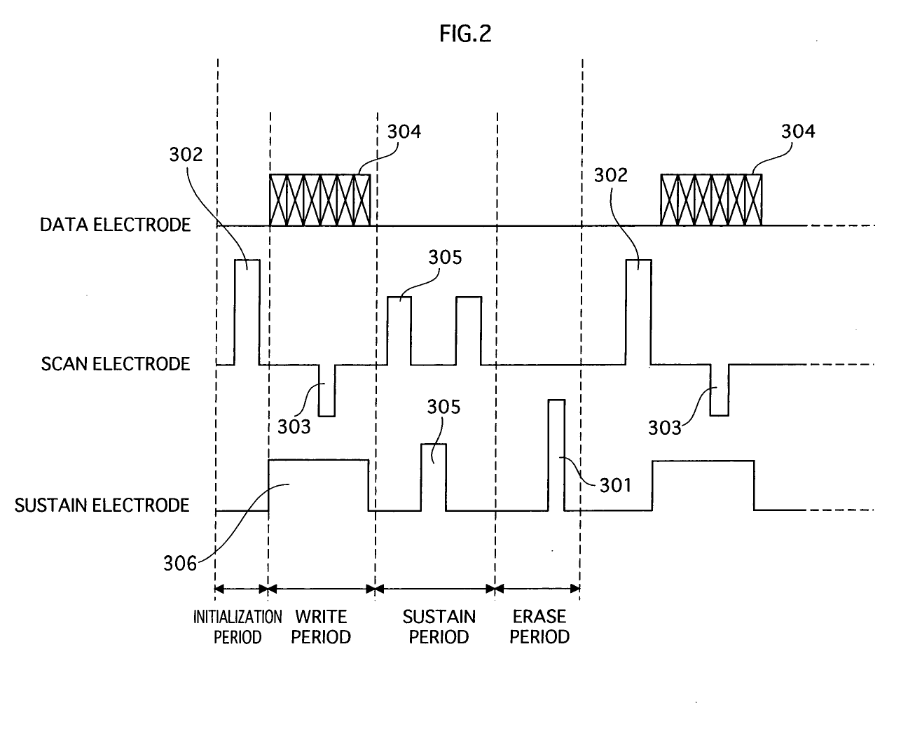

FIG. 3 shows processes performed in a field according to the ADS drive method;

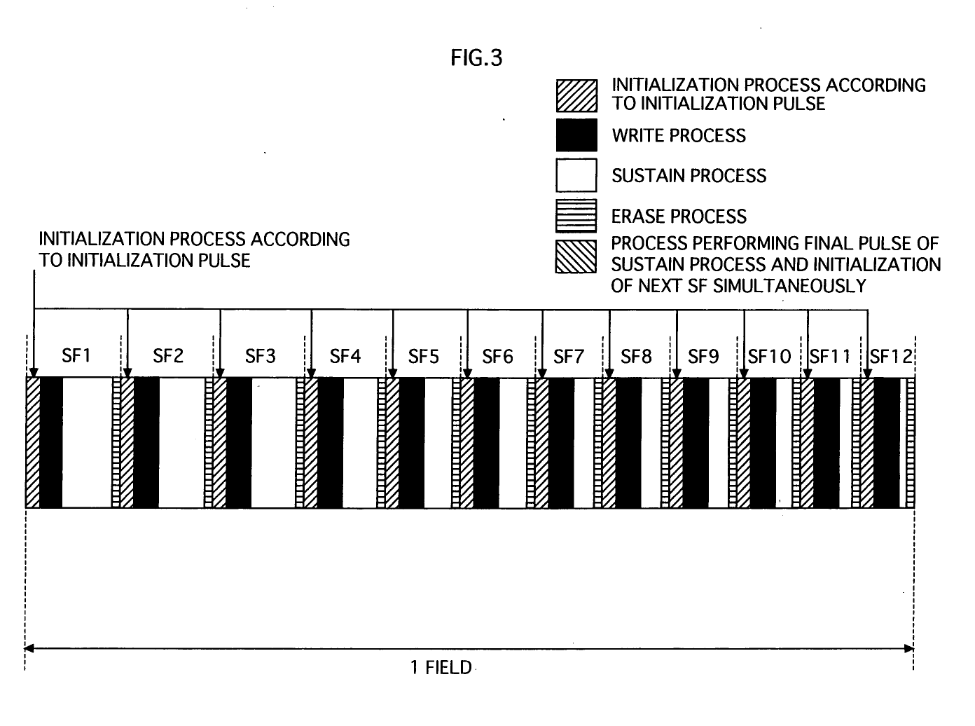

FIG. 4 shows processes performed in a field according to the Real Black drive method;

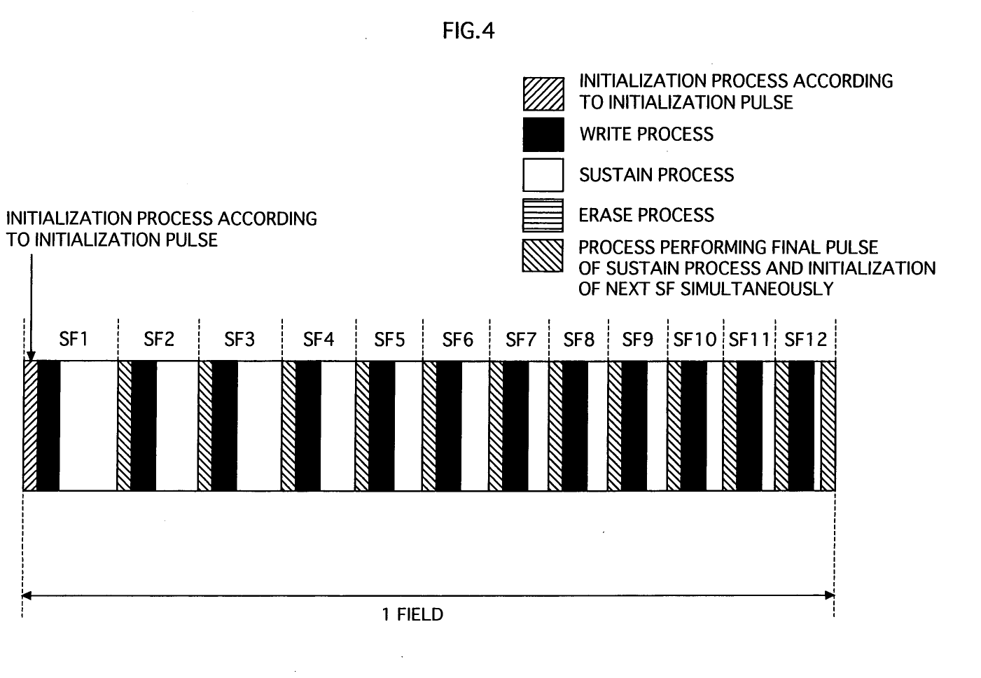

FIG. 5 shows voltage waveforms applied to scan electrodes, sustain electrodes and data electrodes according to the Real Black drive method;

FIG. 6 shows processes performed in a field according to the STCE drive method;

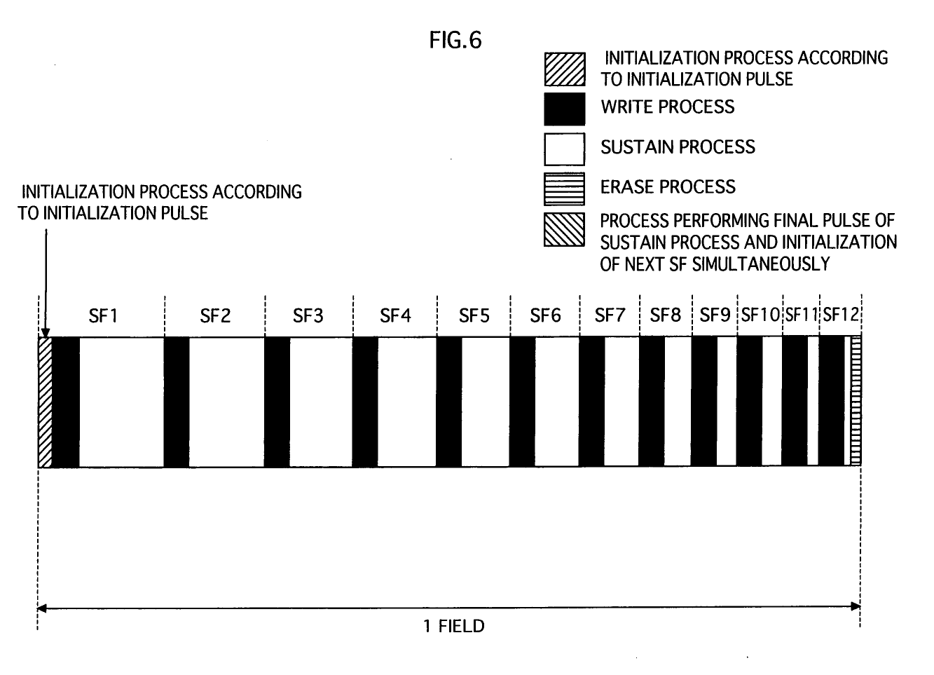

FIG. 7 shows voltage waveforms applied to scan electrodes, sustain electrodes and data electrodes according to the STCE drive method;

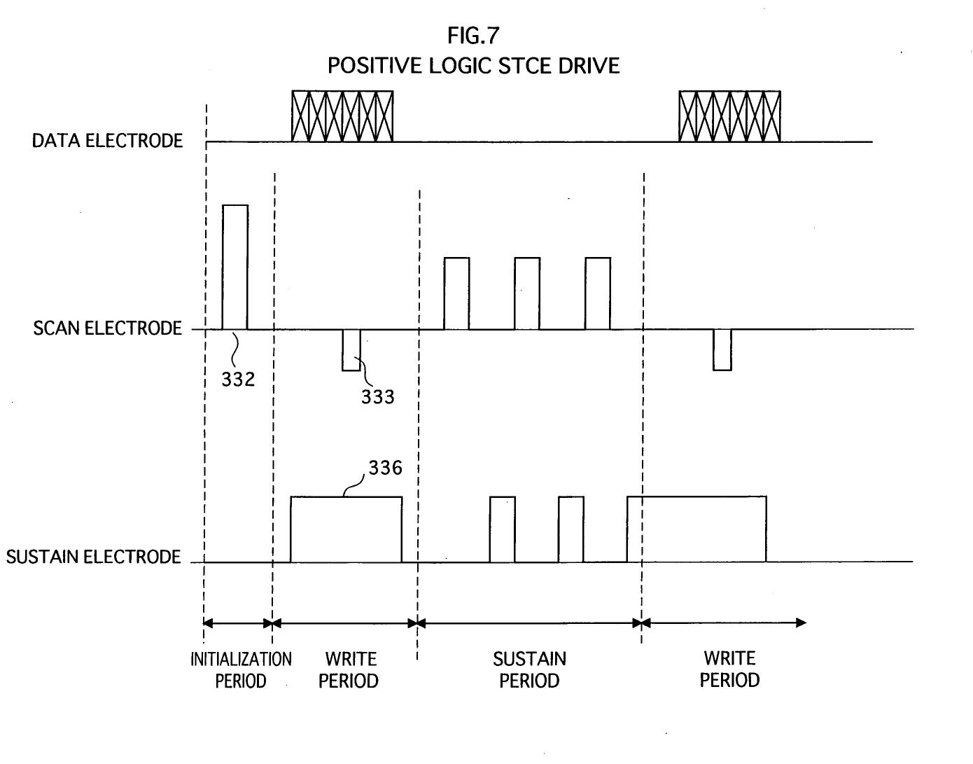

FIG. 8 shows a variation of the STCE drive method;

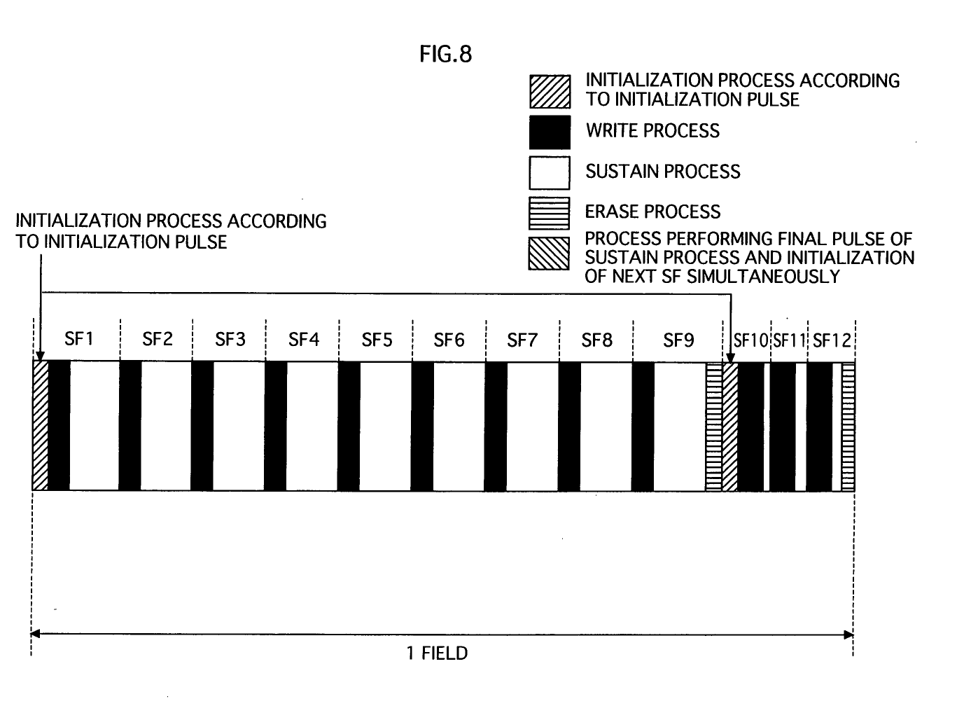

FIG. 9 is a structural drawing of the plasma display device of the present embodiment;

FIG. 10 shows the construction of a field consisting of two S subfield groups, and one A subfield group, in the stated order;

FIG. 11 shows a conversion table which is stored in a subfield conversion unit;

FIG. 12 shows the structure of a field consisting of S subfield groups, and A subfield groups in the order of S,A,S,A;

FIG. 13 shows a conversion table located within the subfield conversion unit;

FIG. 14 shows voltage waveforms applied to scan electrodes, sustain electrodes and data electrodes according to an STCE drive method which is based on a selective erase method;

FIG. 15 shows the structure of a field according to the STCE drive method which is based on the selective erase method;

FIG. 16 shows the contents of the conversion table located within the conversion unit;

FIG. 17 shows an example of processes performed in a field according to the drive method of the present embodiment;

FIG. 18 shows the structure of a field in a case where false contour reduction is taken into consideration;

FIG. 19 shows another example of the processes performed in a field according to the drive method of the present embodiment;

FIG. 20 shows erase processes and initialization processes which do not overlap with other processes, for reforming the wall charge in all subfield pairs which consist of a former subfield belonging to an A subfield group and a latter subfield belonging to an S subfield group;

FIG. 21 shows erase processes and initialization processes which do not overlap with other processes in the subfields that are on the boundaries of each subfield group;

FIG. 22 shows initialization processes which do not overlap with other processes in the first subfield of the field and in all of the subfields of the A subfield groups;

FIG. 23 shows processes in a field in a case where such a selective erase method is applied to FIG. 19;

FIG. 24 shows processes in a field in a case where the selective erase method is applied to FIG. 20;

FIG. 25 shows processes in a field in a case where the selective erase method is applied to FIG. 21; and

FIG. 26 shows processes in a field in a case where the selective erase method is applied to FIG. 22.

### THE BEST MODE FOR CARRYING OUT THE INVENTION

Embodiments and drawings of the present invention are described below. These descriptions show examples only, and the present invention is not limited to these descriptions.

<First Embodiment>

<Structure>

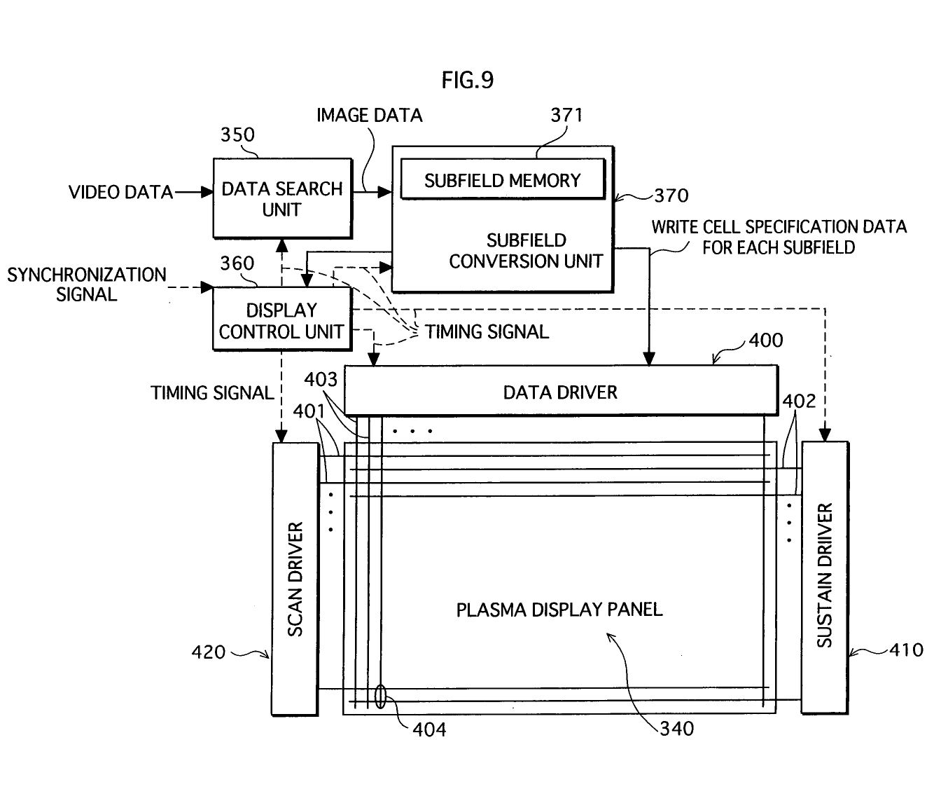

FIG. 9 is a structural drawing of the plasma display device of the present embodiment.

The plasma display device shown in FIG. 9 is made up of a plasma display panel 340, a data search unit 350, a display control unit 360, a subfield conversion unit 370, a data driver 400, a scan driver 420, and a sustain driver 410.

The plasma display panel 340 has a front substrate and a back substrate (which make up a pair of substrates). A plurality of scan electrodes 401 and a plurality of sustain electrodes 402 are arranged lengthwise in a horizontal direction on the front substrate, and the plurality of data electrodes 403 are arranged lengthwise in a vertical direction on the back substrate.

The pluralities of scan electrodes 401 and sustain electrodes 402 are arranged forming a matrix pattern with the plurality of data electrodes 403.

Discharge cells 404 are formed at the points at which scan electrodes 401 and sustain electrodes 402 intersect the data electrodes 403.

Discharge cells 404 contain enclosed discharge gas, and make up sub-pixels on a screen.

One pixel is usually formed from three horizontally-adjacent discharge cells (red, green, blue), that is, three sub-pixels.

The data search unit 350 is inputted with video data.

The video data is data which shows gradation values for every cell of the plasma display panel 340, for example in a case where every cell is to display 256 gradation, the gradation value of every single cell is shown as 8 bits.

The data search unit 350 sequentially forwards image data (gradation values for every cell) to the subfield conversion unit 370.

The forwarding of the image data is performed according to, for example, the arrangement order of cells in the plasma display panel 340.

The subfield conversion unit 370 has conversion tables which contain gradation values, and corresponding information showing which subfields of the field write is to be performed in. For example, when a field is time-shared between 10 subfields, the subfield conversion unit 370 generates write SF specification data (information showing which subfields write is to be performed in of SF1 to SF10), based on both image data of observation cells forwarded from the data search unit 350 and the conversion table, for the said observation cells. Then, based on this write SF specification data, the subfield conversion unit 370 generates write cell specific data for each subfield from SF1 to SF10 showing which cells write is to be performed in, and sends this write cell specific data to the data driver 400.

The display control unit 360 is synchronously inputted with video data and a synchronization signal (for example a horizontal synchronization signal (Hsyc) and a vertical synchronization signal (Vsyc)).

The display control unit 360 sends, based on the synchronization signals, a timing signal designating an image data forward timing to the data search unit 350, a timing signal designating a write timing and a read timing to a subfield memory 371, and timing signals designating pulse application timings to the data driver 400, the scan driver 420, and the sustain driver 410.

The data driver 400 is connected to the plurality of data electrodes 403. The data driver 400 selectively applies write pulses to the plurality of data electrodes 403 in the write period of each subfield, to enable performance of stable write discharge in all of the discharge cells 404.

The scan driver 420 is connected to the plurality of scan electrodes 401.

The scan driver 420 applies initialization pulses, sustain pulses, scan pulses and erase pulses to the plurality of scan electrodes 401 in the initialization period, write period and erase period of each subfield, to enable performance of stable initialization discharge, write discharge and erase discharge in all of the discharge cells 404.

The sustain driver 410 is connected to a plurality of sustain electrodes 402. The sustain driver 410 applies sustain pulses as well as pulses for the performance of write and erase to the plurality of sustain electrodes 402 in the initialization period, write period and erase period of each subfield, to enable performance of stable initialization discharge, write discharge, sustain discharge and erase discharge in all of the discharge cells 404.

<Description of the Drive Method>

Below is a description of the drive method of the present first embodiment.

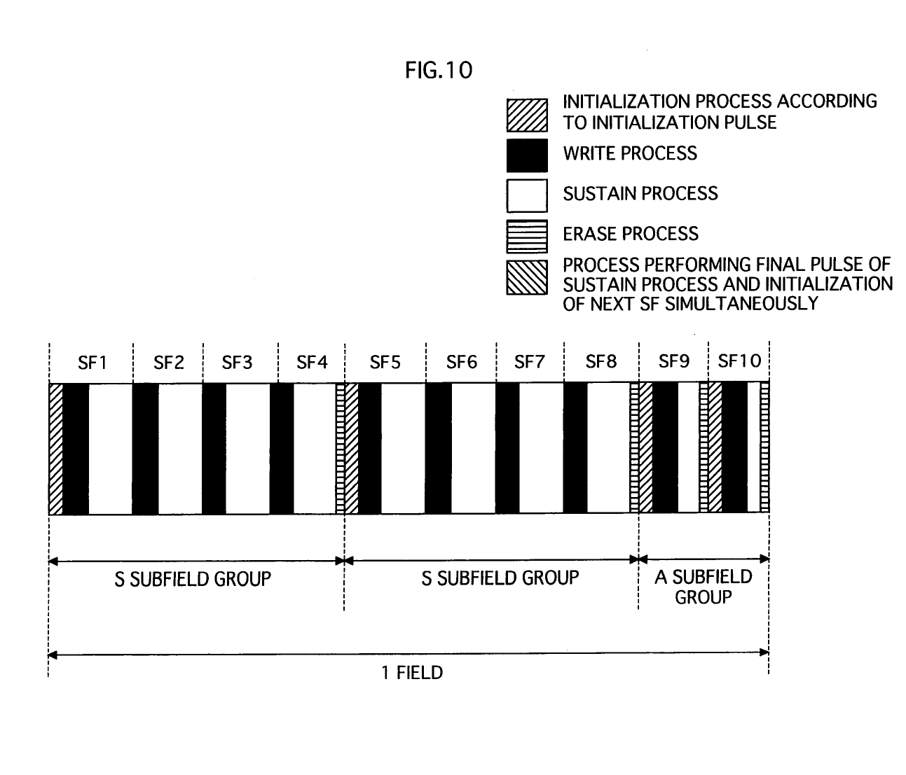

FIG. 10 shows processes performed in a field according to the drive method of the present embodiment.

In the present embodiment a field is time-shared between 10 subfields (SF1 to SF10), as shown in FIG. 10.

Within the 10 subfields, the STCE drive method is applied to the subfield group which has successive subfields from SF1 to SF4, and this subfield group is called STCE 1.

That is to say that (a) write is not performed in every single subfield in STCE 1, but is either not performed at all or is performed only once, and (b) the subfields from SF1, which is the first subfield of STCE 1, until SFm-1 which is the subfield immediately preceding SFm (SFm being the subfield in which write is performed) are subfields having continuously extinct sustain periods, and (c) the subfields from SFm to SF4, which is the last subfield of STCE 1, are subfields having continuously illuminated sustain periods.

Note that in a case where write is not performed in STCE 1, all of the subfields in STCE 1 are extinct subfields.

Further, the STCE drive method also is applied to the subfield group which has successive subfields from SF5 to SF8, and this subfield group is called STCE 2.

The ADS drive method is applied to the subfield group which has successive subfields from SF9 to SF10, and this subfield group is called ADS 1.

In other words, initialization, write, sustain and erase processes are performed in each subfield of ADS 1.

Here, for convenience, the subfield groups to which the STCE drive method is applied are called S subfields, and the subfield groups to which the ADS drive method is applied are called A subfields.

That is to say, in the present embodiment, one field consists of two S subfield groups and one A subfield group.

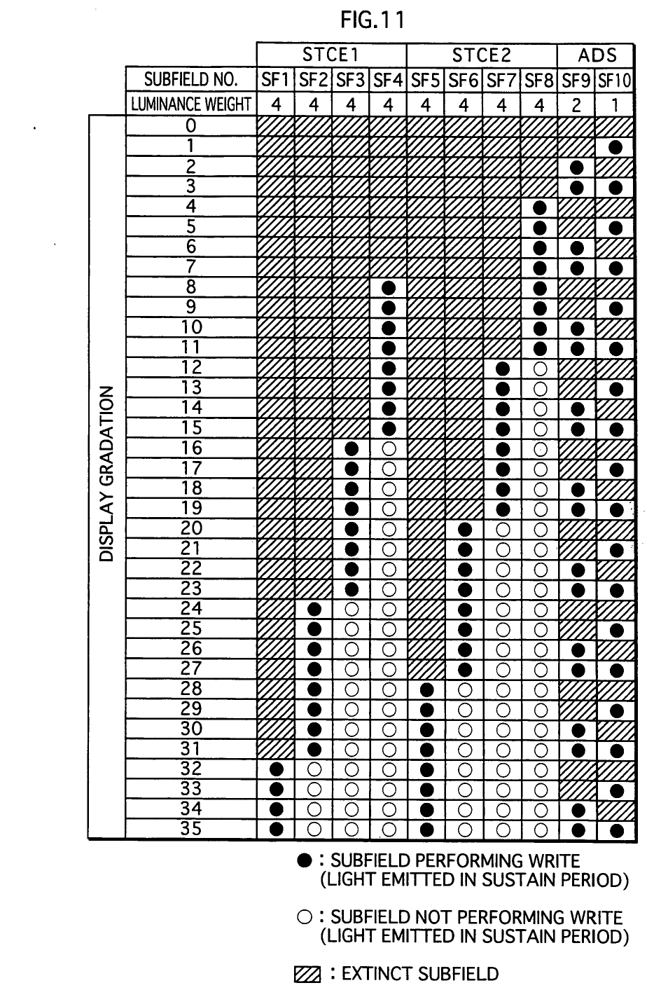

FIG. 11 shows a conversion table stored in the subfield conversion unit 370.

In this conversion table the rectangular areas shaded diagonally show subfields having an extinguished state in the sustain periods, and the unshaded rectangular areas show subfields having an illuminated state in the sustain periods.

The black filled-in circles inside the rectangles show that write is performed, and the white circles show that light is emitted without write being performed, this being the part of the performance which is unique to STCE drive.

Reasons for the performance of the abovementioned drive method are mentioned below.

As shown in FIG. 11, in STCE1 and STCE2, because the frequency of repeated light emission in each S field is greater than in ADS 1, the luminance emission peaks in are likely to appear in STCE1 and STCE2.

According to this method, even if the image refresh rate of a frame is 50 frames/second, since two luminance peaks exist in one frame, the refresh rate falsely becomes 100 frames/second, thus flicker is not sensed by the human eye.

Incidentally, in a gradation range of 0 to 7, because light may not even be emitted once in STCE 1, the abovementioned effect of a false increase of the refresh rate is not gained, however since there is a small fluctuation width of emission luminance in such a low luminance image, flicker does not tend to occur.

In the present embodiment, two S subfield groups and one A subfield group are provided in one field. The A subfield group performs a role of providing a number of gradations which are insufficient when only S subfield groups are provided in the field.

Here, as shown in FIG. 10, a case in which one field is made up of two S subfield groups each consisting of four subfields, and one A subfield group consisting of two subfields is called case 1, and another case in which one field is made up of two S subfield groups each consisting of five subfields is called case 2.

In both case 1 and case 2, one field is made up of 10 subfields.

However, in case 1, according to the setting of weights, the largest number of gradations is 5*5*3=75, and in case 2 the largest number of gradations is 6*6=36, thus the number of gradations increases when an A subfield group is included in the field.

Incidentally, according to the normal selective write method, the position of the A subfield group within the field is preferably set in at least the middle part, or more preferably the end part of the field.

Such a position is preferable because it alleviates the likely occurrence of false contour, which is a contour that is not in the actual video, but appears due to uneven color and blurred color and the like in middle gradations. The uneven and blurred color appears when a moving image is displayed in a case where an A subfield group is positioned preceding an S subfield group, because, since light emission is concentrated in the subfields in the end part of an S subfield group, the frequency of periods in which there is no light emission between the light emission of the A subfield group and the light emission of the S subfield group is increased, and light emission tends to become intermittent.

Note that within a plurality of S subfield groups, the same value of luminance weights is assigned for every subfield in every S subfield group, and the relationships between the number of gradations and corresponding subfields performing write are set in such a way that there is almost no difference between them. This is so that the peak level of light emission does not excessively decrease in any S subfield group.

As mentioned above, when the plasma display panel is driven according to the present embodiment, by providing two S subfield groups and one A subfield group within a field, as well as the A subfield group (to which the ADS drive method is applied) assisting in providing a number of gradations which are insufficient when only S subfield groups (to which the STCE drive method are applied) are provided, the refresh rate (frame/second) appears to double and flicker occurs less easily because the luminance emission peak point is broken up into each S subfield group, and thus appears more frequently.

Note that in the present embodiment, although it is stated that the number of S subfield groups to be set in a field is preferably two, there is no restriction on setting three or more S subfield groups in a field. For example, in a case where the refresh rate (frame/second) is extremely low, the setting of three or more S subfield groups in a field is effective for flicker-free refresh.

Further, although one A subfield group is set in a field in the present embodiment, the number of A subfield groups in a field is not restricted to one.

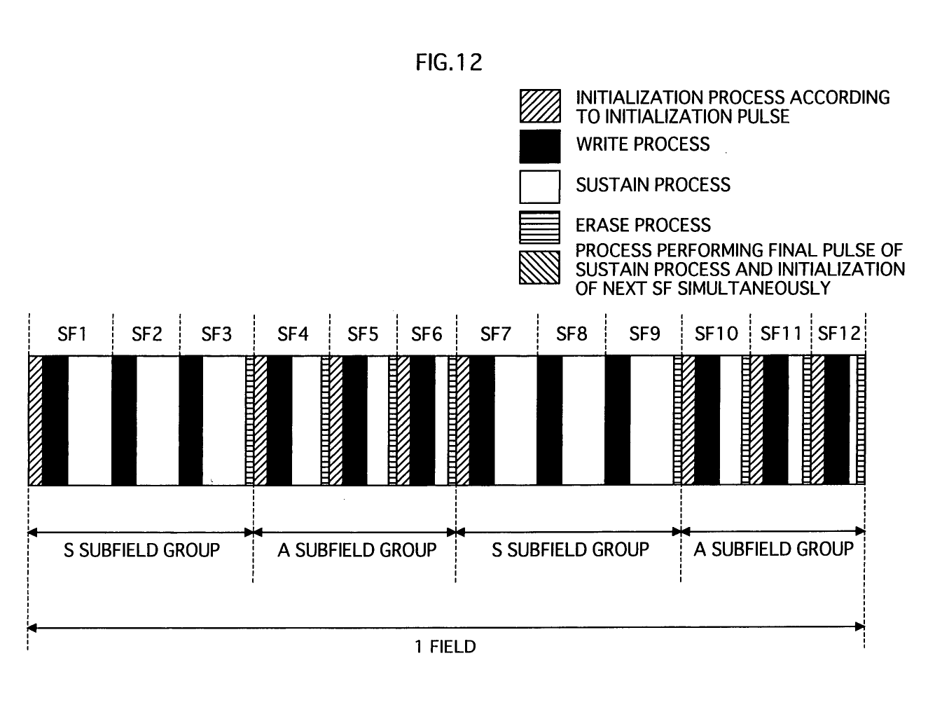

More specifically, as shown in FIG. 12, two S subfield groups each consisting of three subfields, and two A subfield groups each consisting of three subfields, may be set in a field in the order of S,A,S,A.

Further, here the A subfield group is made up of two or more subfields. However even if the A subfield group was replaced by a single subfield, an effect of an increase in the number of gradations would still be gained, for example the maximum number of gradations in the abovementioned case 1 would be 5*5*2=50, and the maximum number of gradations in case 2 would be 6*6=36.

Here, the S subfield group is positioned before the A subfield group within one field in order to alleviate the occurrence of false contour which is previously mentioned.

Therefore in a case where pluralities of both A subfield groups and S subfield groups are positioned in a field, it is preferable to position an S subfield group at the front of the field, and then position A and S subfield groups in an alternating arrangement.

Also, as mentioned above, a more effective increase in the number of gradations can be gained when there are two A subfield groups in a field than when there is only one A subfield group in a field.

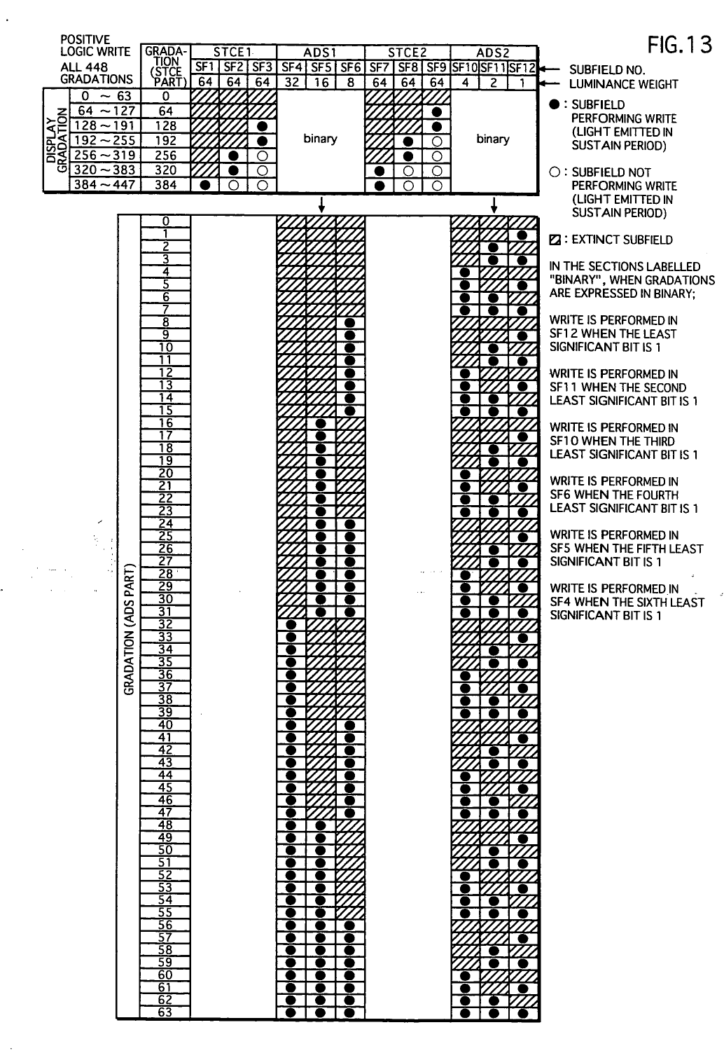

FIG. 13 shows the contents of a conversion table provided in the subfield conversion unit 370 for the purpose of setting these arrangements of subfield groups.

As shown in FIG. 13, display of gradations 0 to 447 is possible when the present drive method is used.

Further, in the present embodiment the plasma display panel is driven according to the STCE drive method and the ADS drive method, based on the selective write method, however drive may also be performed based on the selective erase method.

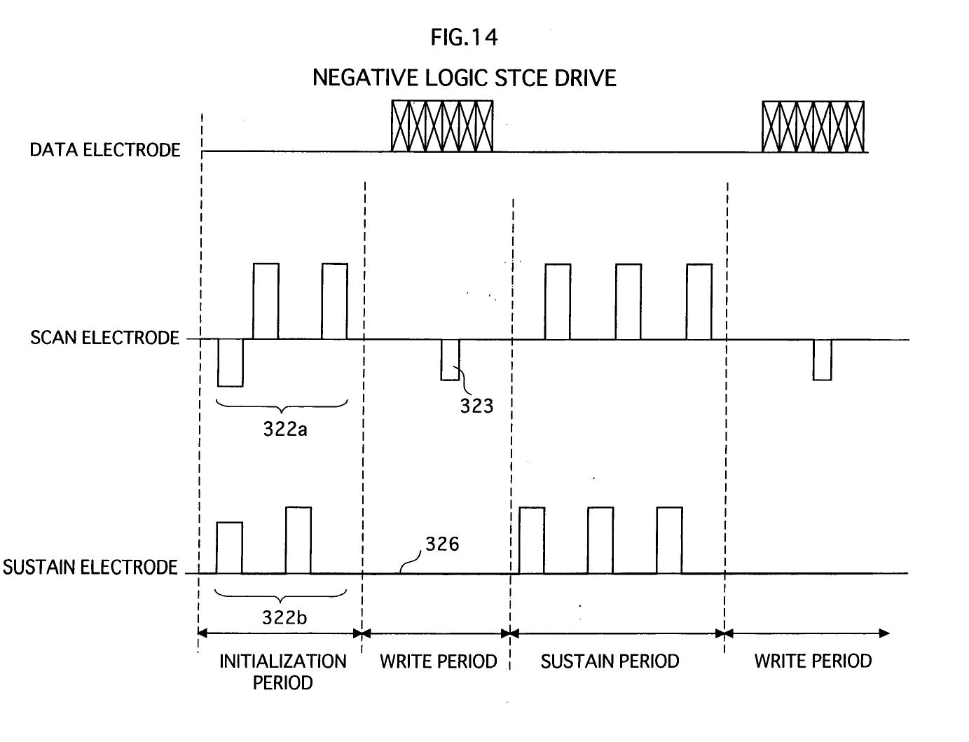

FIG. 14 shows voltage waveforms which are applied to scan electrodes 101, sustain electrodes 102 and data electrodes 103 in the STCE method based on the selective erase method.

In the initialization period, the differences between the STCE drive method based on the selective erase method and the STCE drive method based on the selective write method are that in the former method, (a) pulses 322a, being a negative voltage pulse followed by positive voltage pulses, are applied to all of the scan electrodes 101, and (b) positive voltage pulses 322b are applied to all of the sustain electrodes 102.

Further, in the write period, the STCE method based on the selective erase method differs from the STCE drive method based on the selective write method in that no voltage is applied to the sustain electrodes 102, and a negative voltage pulse 323 is applied only to the scan electrodes 101 which correspond to cells in which light emission is to be ceased.

In a case where the plasma display panel is driven according to the STCE drive method based on the selective erase method, it is preferable to set the relative positions of the S subfield groups and A subfield groups within the field so that A subfield groups are positioned in front of S subfield groups.

This position setting is required in view of the desired alleviation of false contour which was mentioned previously. Because light emission is concentrated in the subfields in the front parts of S subfield groups in the STCE drive method based on the selective erase method, if an A subfield group is positioned after an S subfield group, the frequency of periods in which no light is emitted between the light emission of the S subfield group and the light emission of the A subfield group increases, and light emission tends to become intermittent, thus resulting in likely occurrences of false contour.

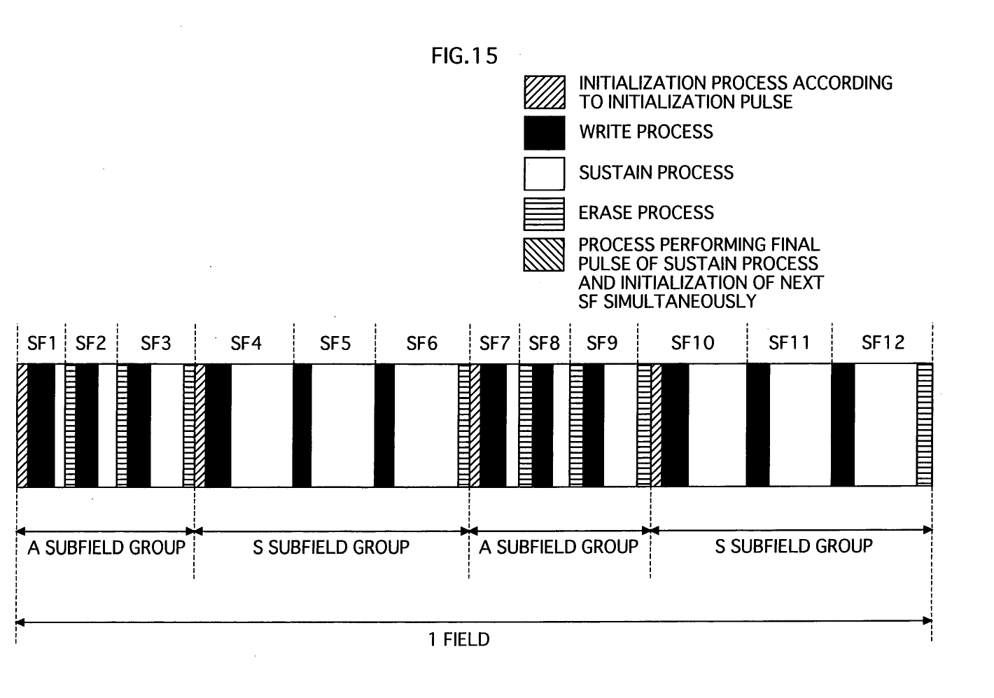

More specifically, FIG. 12 shows, for example, the structure of one field made up of S subfield groups and A subfield groups to which the STCE drive method based on the selective write method is applied. If an ADS or an STCE method based on the selective erase method were to be applied to this field, the subfield groups would preferably be set in the order A,S,A,S, as shown in FIG. 15.

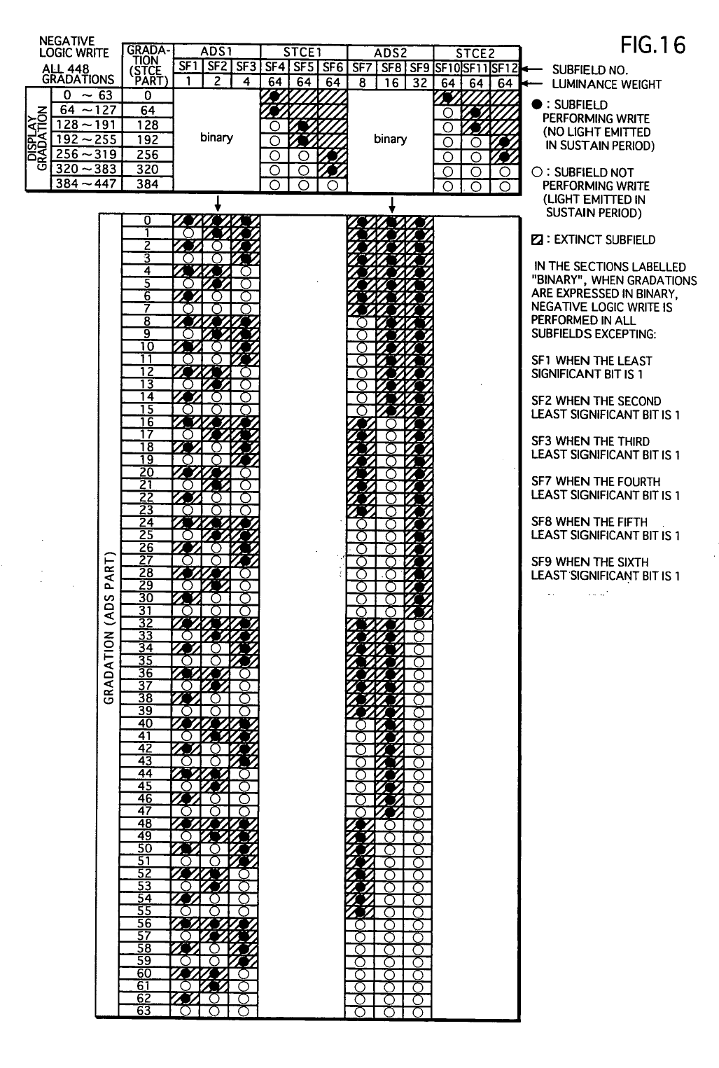

FIG. 16 shows the contents of a conversion table located in the subfield conversion unit 370 which is for performing the position settings of subfield groups.

Note that when using this drive method, display of gradations 0 to 447 is possible, in a similar way to as illustrated in FIG. 13.

Further, although the plasma display panel drive method of the present embodiment is a method which is effective in solving the problem of flicker during image display based on the PAL system video standard, which has a comparatively low refresh rate (frames per second), this method may also be used for image display based on the NTSC (National Television Standards Committee) system video standard, or other system video standards.

<Second Embodiment>

<Structure>

The structure of the plasma display device of the present embodiment is similar to the structure shown in FIG. 9, and has voltage application patterns in the sustain period, erase period and initialization period which differ from those in the first embodiment.

<Explanation of the Drive Method>

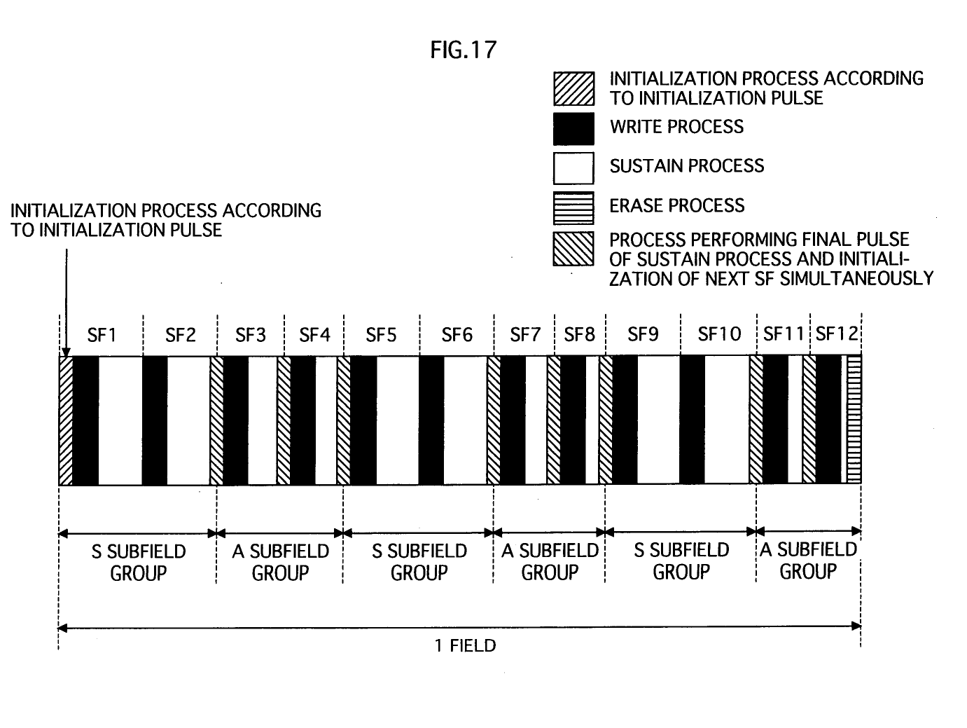

FIG. 17 shows one example of the processes performed in a field according to the drive method of the present embodiment.

As shown in FIG. 17, one field is time-shared between 12 subfields (SF1 to SF12), which make up three S sub field groups each consisting of two subfields, and three A subfield groups each consisting of two subfields, in the order of S,A,S,A,S,A.

The STCE drive method based on the selective write method is applied to the S subfield groups.

Here SF2 and SF3, which are positioned on the boundaries of different subfield groups, will be described.

SF2 is a final subfield in an S subfield group, and SF3 is a first subfield in an A subfield group.

In the first embodiment, the erase process is performed in the final period of SF2, and the initialization process is performed in the first period of SF3, however the present embodiment differs from the first embodiment in that the erase process is not performed in SF2, and that part of the sustain process performed in SF2, and the initializing period performed in SF3 are performed in parallel.

Processes are performed in a similar way in the subfield pairs SF4 and SF5, SF6 and SF7, SF8 and SF9, and SF10 and SF11, which are positioned on the boundaries of subfield groups.

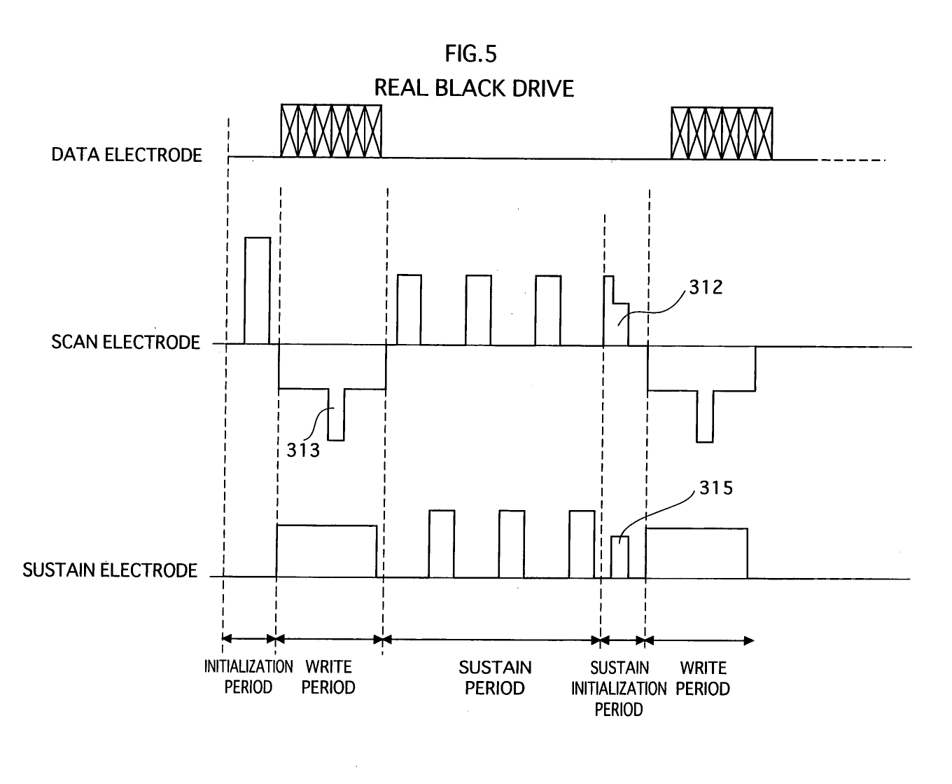

The voltage application patterns for when part of the sustain process is performed parallel to the initialization process are as shown by the application patterns of sustain pulse 315 and initialization pulse 312 in FIG. 5.

Reasons for performing such a drive method are mentioned below.

By providing three S subfield groups and three A subfield groups in an alternating arrangement, as well as the A subfield groups (to which the ADS drive method is applied) assisting in providing a number of gradations which are insufficient when only S subfield groups (to which the STCE drive method are applied) are provided, the refresh rate (frame/second) appears to triple and flicker occurs less easily because the luminance emission peak point is broken up into each S subfield group, and thus appears more frequently.

Further, in the present embodiment, because part of the sustain process is performed parallel to the initialization process, light emission is suppressed in periods where light should not be emitted, that is, contrast degradation, which results from an unnecessary increase in luminance when low-gradation display is performed, can be prevented.

In the plasma display panel drive method according to the present embodiment, by providing three S subfield groups and three A subfield groups in a field as mentioned above, effects of suppression of the occurrence of flicker and maintenance of the number of gradations can be gained similarly to in the first embodiment, and furthermore, in the present embodiment, because part of the sustain process is performed parallel to the initialization process, light emission is suppressed in periods where light should not be emitted, that is, contrast degradation, which results from an unnecessary increase in luminance when low-gradation display is performed, can be prevented.

Note that in the present embodiment, the numbers of S subfield groups and A subfield groups set in a field are not limited to three. Rather, a field may be set so as to have at least one A subfield group and at least two S subfield groups.

Further, in the present embodiment, driving of the plasma display panel according to the STCE drive method is performed based on the selective write method, however it may also be performed based on the selective erase method.

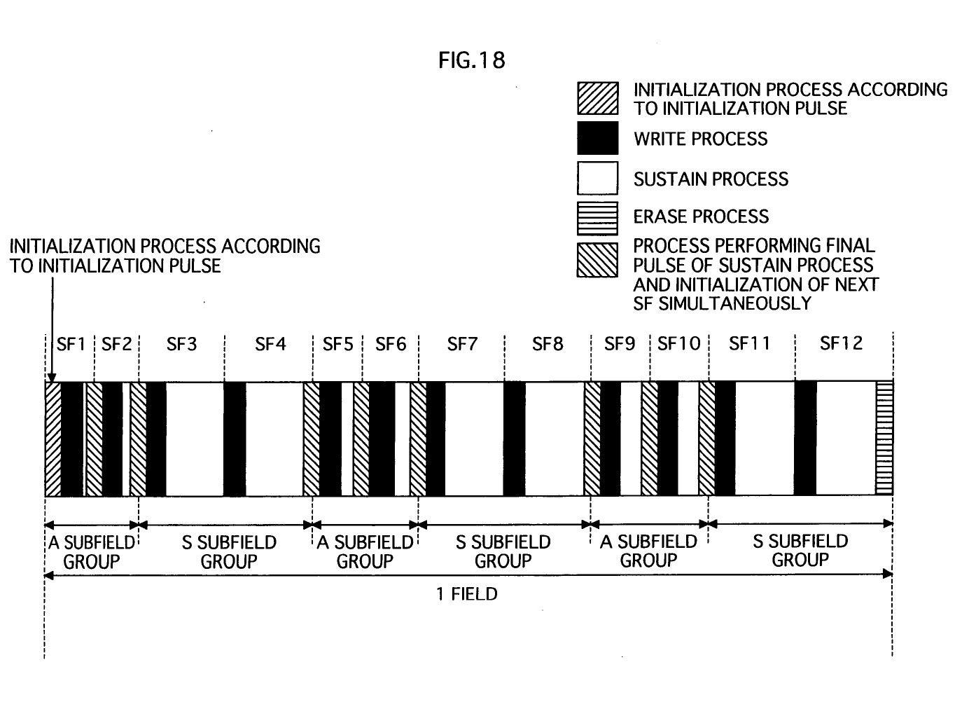

In a case where drive is performed based on the selective erase method, in view of the desired alleviation of false contour, it is preferable to set the relative positions of the S subfield groups and A subfield groups within the field so that the A subfield groups are positioned in front of the S subfield groups, as shown in FIG. 18.

This is because, as was explained in the first embodiment, since light emission is concentrated in the subfields in the front part of S subfield groups in the STCE drive method based on the selective erase method, when an A subfield group is positioned after an S subfield group, the frequency of periods in which no light is emitted between the light emission of the S subfield group and the light emission of the A subfield group increases, and light emission tends to become intermittent, thus resulting in likely occurrences of false contour.

Further, although the plasma display panel drive method of the present embodiment is a method which is effective in solving the problem of flicker during image display based on the PAL system video standard, which has a comparatively low refresh rate (frames per second), this method may also be used for image display based on the NTSC system video standard, or other system video standards.

<Third Embodiment>

<Structure>

The structure of the plasma display device of the present embodiment is as shown in FIG. 9, and the arrangement of the initialization periods and the erase periods within a field differs from the arrangement in the second embodiment.

<Description of the Drive Method>

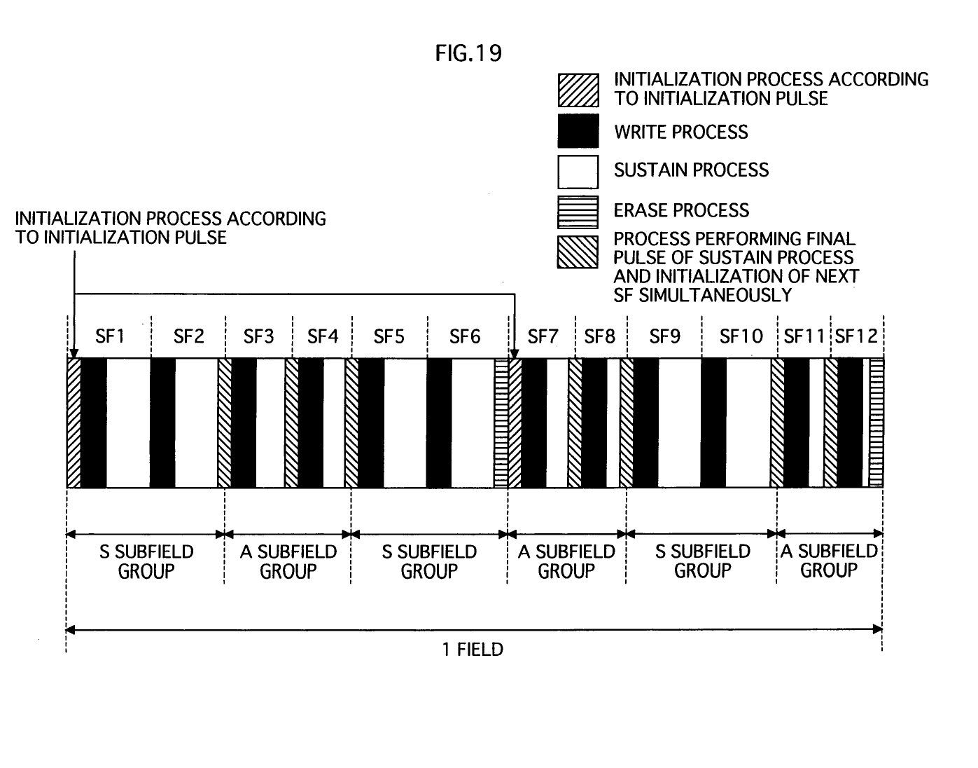

FIG. 19 shows one example of the processes performed in a field according to the drive method of the present embodiment.

As shown in FIG. 19, one field is time-shared between 12 subfields (SF1 to SF12) which make up three S subfield groups each consisting of two subfields, and three A subfield groups each consisting of two subfields, in the order of S,A,S,A,S,A.

The STCE drive method based on the selective write method is applied to the S subfields.

Here SF6 and SF7, which are positioned on the boundaries of different subfield groups in the center of a field, will be described.

SF6 is the final subfield of an S subfield group, and SF7 is the first subfield in an A subfield group.

In the plasma display panel drive method mentioned of the second embodiment, part of the sustain process performed in SF6 is performed parallel to the initialization process performed in SF7, however the present embodiment differs from the second embodiment in that the erase process is performed at the end of SF6, and the initialization process is performed in a normal way in the head of SF7.

In other words, when considering SF7 and SF6 only, the present embodiment is similar to the first embodiment.

Reasons for the performance of the abovementioned drive method are mentioned below.

In a case where, as in the plasma display panel drive method of the previously mentioned second embodiment, the initialization process which performs only initialization (without overlapping with any other process) is performed only in the first subfield of a field, because wall charge is not formed during the whole field from the point of performance of initialization, for example for 20 ms in a PAL video standard (50 fields/second), write error is likely to occur in the subfields in the end part of the field.

Therefore, an initialization process which performs only initialization (without overlapping with any other process) is performed both in the first subfield of the field and the first subfield (SF7) of a subfield group positioned near the center of the field.

Strictly speaking, when luminance is increased by light emission (unrelated to image display), which is generated from the initialization discharge in SF7, contrast deteriorates somewhat, however since the period of the initialization process is very short when viewed in comparison with one field, this deterioration does not create a problem.

According to the present embodiment, by performing the erase processes and initialization processes as mentioned above in two adjacent subfields which are positioned on the boundaries of different subfield groups near the center of a field, that is to say, in a partial range of a field, write error can be suppressed, and, as in the second embodiment, (a) flicker occurrence can be suppressed, (b) a number of gradations can be maintained, and (c) contrast deterioration can be alleviated.

Note that although the plasma display panel drive method of the present embodiment is a method which is effective in solving the problem of flicker during image display based on the PAL system video standard, which has a comparatively low refresh rate (frames per second), this method may also be used for image display based on the NTSC system video standard, or other system video standards.

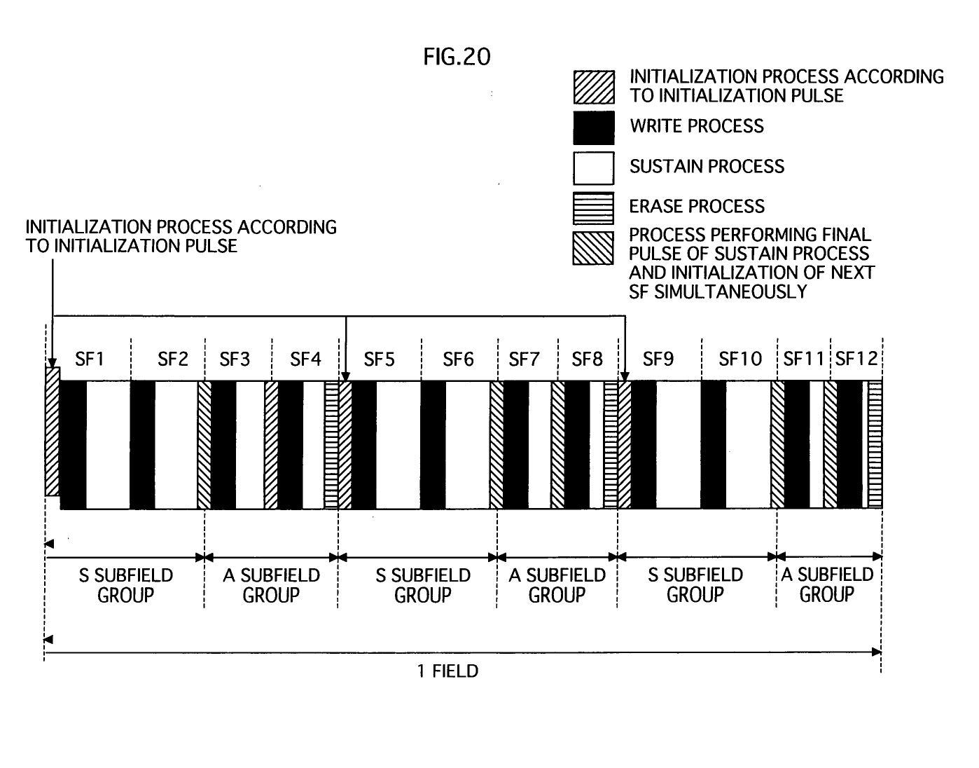

Further, in the present embodiment, in order to reform the wall charge, both the erase process, and the initialization process which does not overlap with other processes, are performed in the two subfields which are positioned on the boundaries of different subfield groups in the center of a field (case 3), as shown in FIG. 19. However the present embodiment is not limited to this. For example, as shown in FIG. 20, the erase process and the initialization process which does not overlap with other processes may be performed to reform the wall charge in all of the subfield pairs of a field in which the first subfield belongs to an A subfield group and the last subfield belongs to an S subfield group (case 4).

Write error is further alleviated according to the performance of the above erase and initialization processes.

However there is a less effective alleviation of contrast degradation according to the performance of these processes.

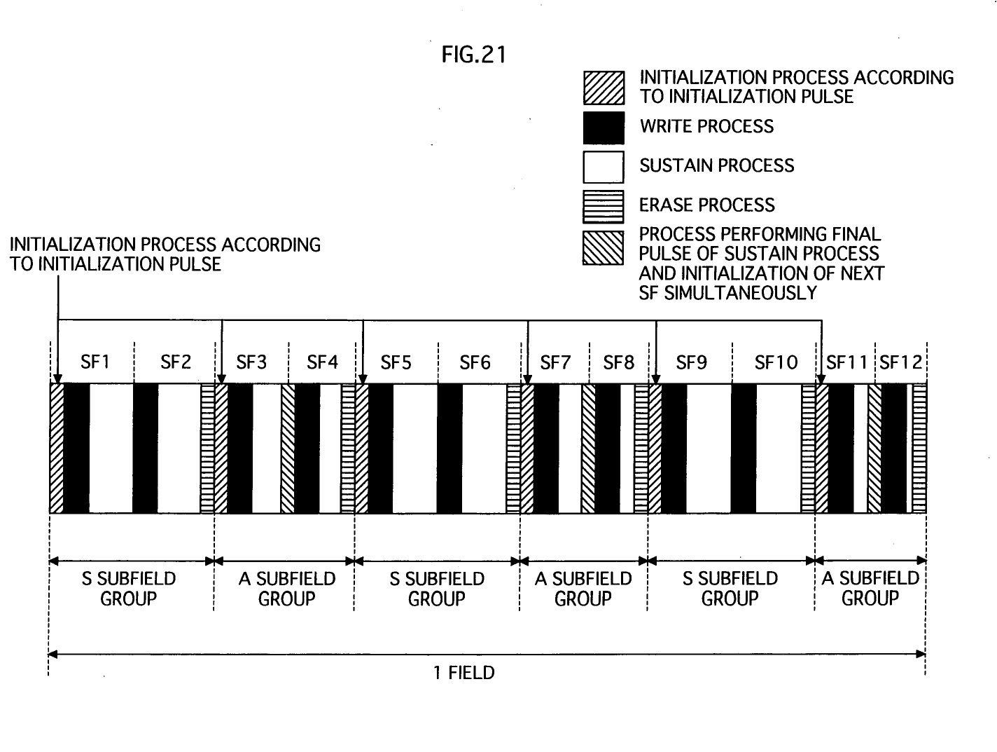

Also, as shown in FIG. 21, the erase process and the initialization process which does not overlap with other processes may be performed in all of the subfield pairs which are on the boundaries of each subfield group (SF2 and SF3, SF4 and SF5, SF6 and SF7, SF8 and SF9 and SF10 and SF11) (case 5).

Write error is further alleviated according to performance of the above processes.

However, there is a less effective alleviation of contrast degradation.

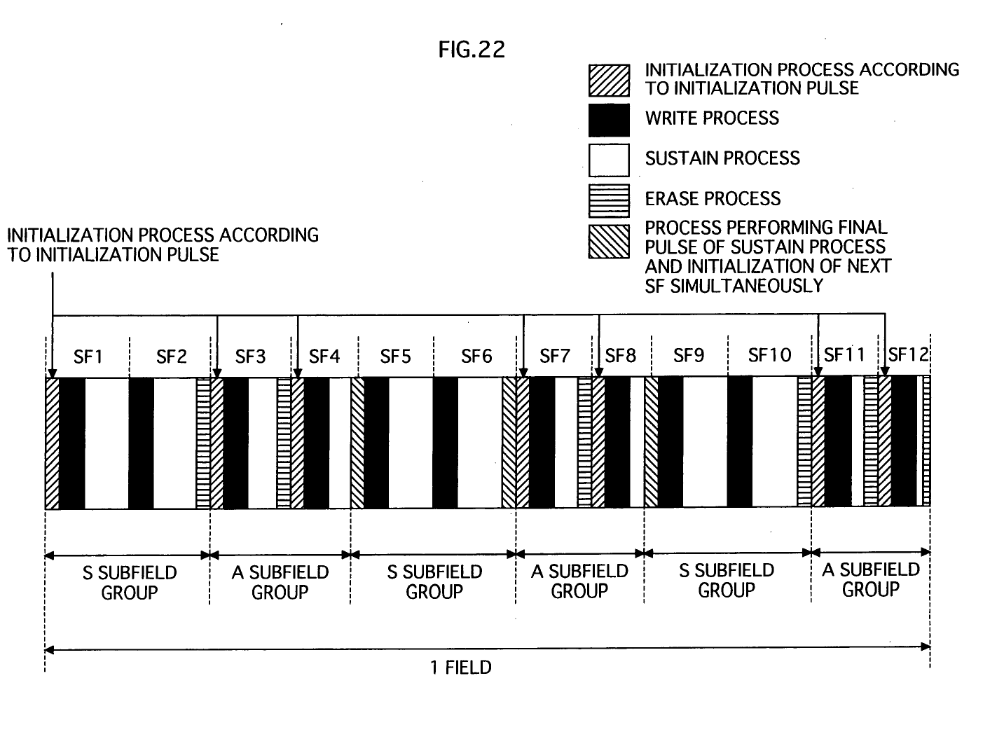

Further, as shown in FIG. 22, the initialization process which does not overlap with other processes may be performed in the first subfield in the field and all of the subfields belonging to A subfield groups (case 6).

In such a case the erase process is performed in the last subfields in the S subfield groups which are positioned in front of the A subfield groups.

Further, in the present embodiment, although the plasma display panel drive according to the STCE drive method is performed based on the selective write method, it may also be performed based on the selective erase method.

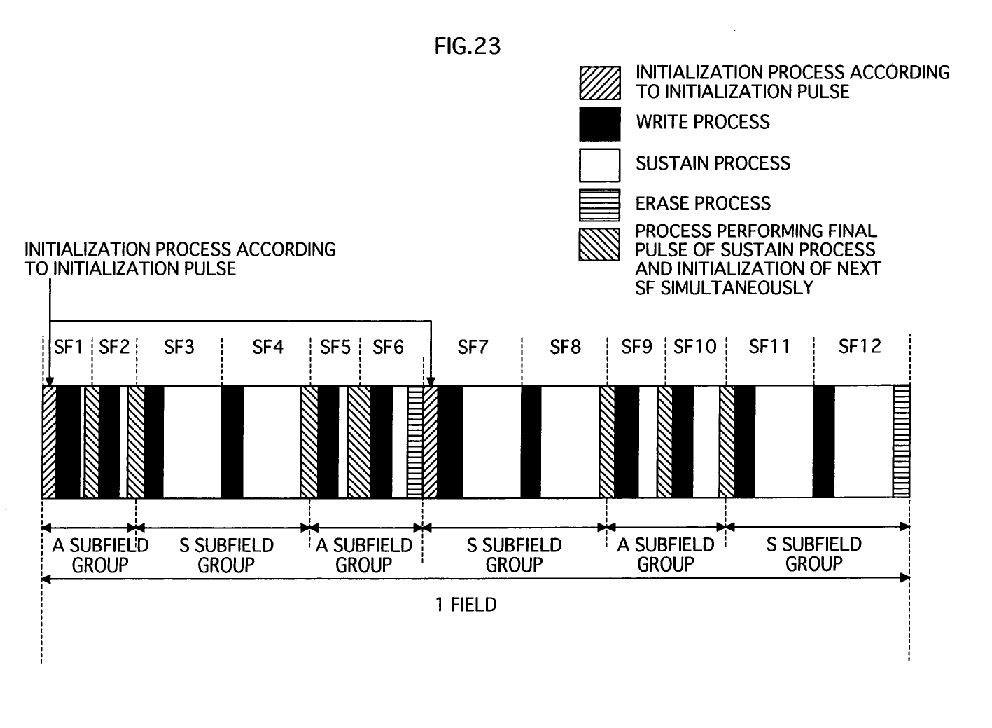

FIG. 23 shows processes in a field in a case where such a selective erase method is applied to the abovementioned case 3.

Incidentally, in view of the desired alleviation of false contour, the relative positions of the S subfield groups and A subfield groups are arranged within the field so that A subfield groups are positioned in front of S subfield groups.

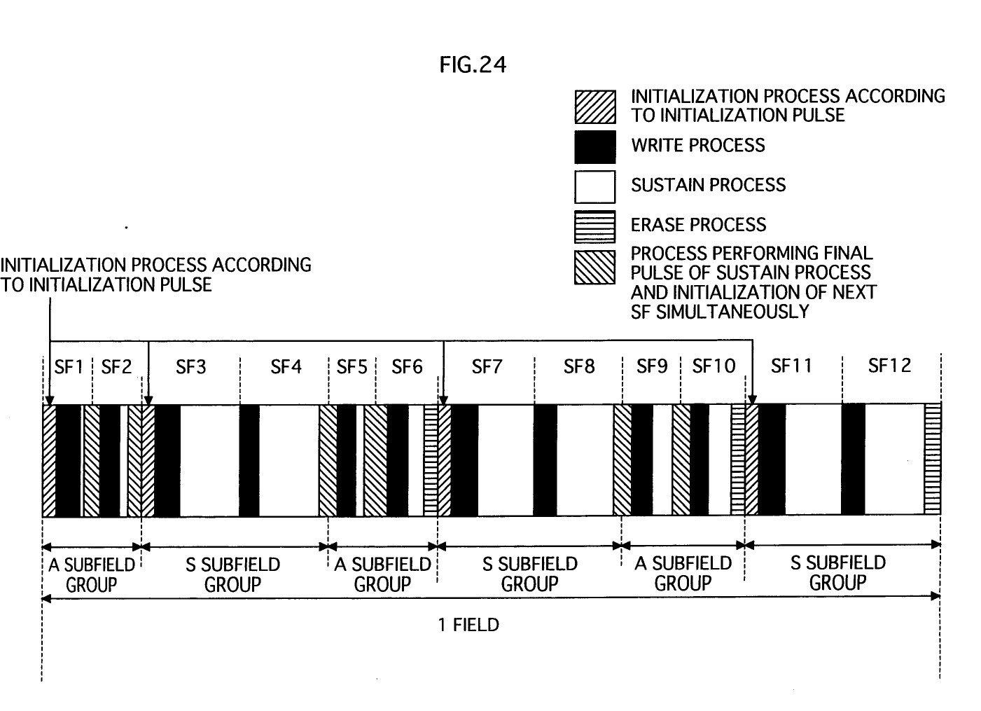

FIG. 24 shows processes in a field in a case where the selective erase method is applied to the abovementioned case 4.

In a similar arrangement to the above case, in view of the desired alleviation of false contour, the relative positions of the S subfield groups and A subfield groups are arranged within the field so that A subfield groups are positioned in front of S subfield groups.

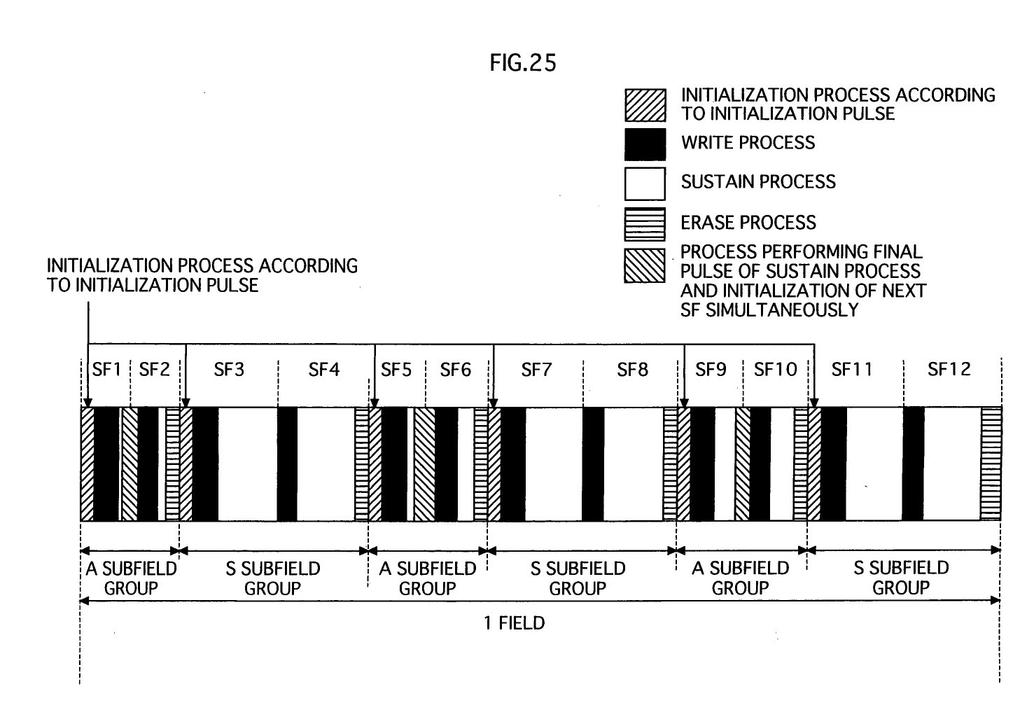

FIG. 25 shows processes in a field in a case where the selective erase method is applied to the abovementioned case 5.

In a similar arrangement to the above cases, in view of the desired alleviation of false contour, the relative positions of the S subfield groups and A subfield groups are set within the field so that A subfield groups are positioned in front of S subfield groups.

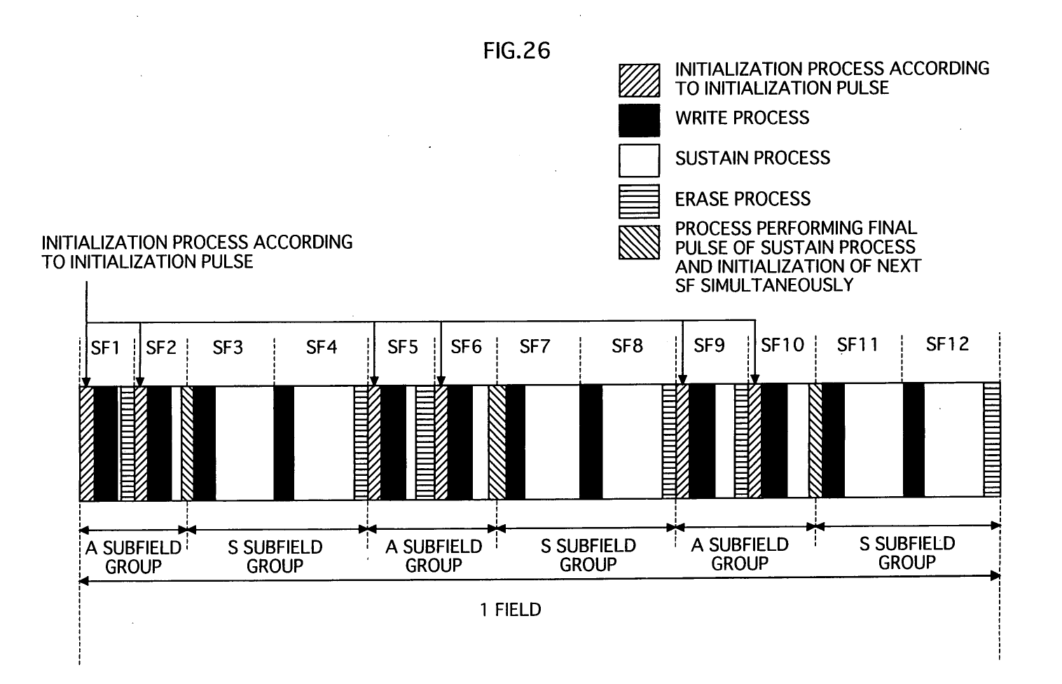

FIG. 26 shows processes in a field in a case where the selective erase method is applied to the abovementioned case 6.

In a similar arrangement to the above cases, in view of the desired alleviation of false contour, the relative positions of the S subfield groups and A subfield groups are arranged within the field so that A subfield groups are positioned in front of S subfield groups.

Industrial Applicability

The present invention can be applied to plasma display panel drive devices used in televisions and computer monitors and the like.

1. A plasma display panel drive method for performing gradation display by selecting a subfield from a plurality of subfields gained by time-sharing a field according to a luminance level of an input image signal, performing write in the selected subfield by applying a voltage to cells, and causing cells to perform sustained light emission in the subfield corresponding to a result of the write, wherein
the field includes two or more first subfield groups and one or more second subfield groups,
each first subfield group is set so that a state of one of extinction and light emission is sustained until before a first write is performed, and the opposite of the state before the first write is sustained after the first write is performed, and
each second subfield group is set so that the state of one of extinction and light emission is the opposite state only during the subfield in which write is performed.

2. The plasma display panel drive method of claim 1, wherein
the first subfield groups and the second subfield groups are arranged in an alternating order in the field.

3. The plasma display panel drive method of claim 2 wherein
a first subfield group is at a head of the field, and in each first subfield group a state of continuous extinction is sustained until before the first write is performed, and a state of light emission is continued after the first write is performed.

4. The plasma display panel drive method of claim 2 wherein
a second subfield group is at a head of the field, and in each first subfield group a state of continuous light emission is sustained until before the first write is performed, and a state of extinction is continued after the first write is performed.

5. The plasma display panel drive method of claim 1, wherein
an erase step of erasing a wall charge in all of the cells is provided in the final subfield of each first subfield group.

6. The plasma display panel drive method of claim 1, wherein
an erase step of erasing the wall charge in all of the cells is provided in all of the subfields belonging to the second subfield groups.

7. The plasma display panel drive method of claim 1, wherein
an erase step of erasing the wall charge in all of the cells is provided in a final subfield of the first subfield group, and in a final subfield of each of the second subfield groups.

8. The plasma display panel drive method of claim 1, wherein
an initialization step of applying an initialization pulse in advance to cause initialization discharge in all of the cells at once, thereby forming a wall charge, is provided in a subfield immediately succeeding the first subfield group, partly parallel to a sustain step provided in a last subfield of the first subfield group.

9. The plasma display panel drive method of claim 1, wherein
an initialization step of applying, in advance, an initialization pulse to cause an initialization discharge in all of the cells at once and thereby form a wall charge, is performed in a latter of two adjacent subfields within a second subfield group, partly parallel to a sustain step provided in a former of the two adjacent subfields.

10. The plasma display panel drive method of claim 5, wherein
an initialization step of applying an initialization pulse to cause an initialization discharge in all of the cells at once and thereby form the wall charge is provided in each subfield that immediately succeeds a subfield in which erase is performed.

11. The plasma display panel drive method of claim 1, wherein
an initialization step of applying an initialization pulse to cause an initialization discharge in all of the cells at once and thereby form a wall charge is provided in a subfield at a head of the field only.

12. The plasma display panel drive method of claim 1, wherein
an initialization step of applying an initialization pulse to cause the uniform initialization discharge in all of the cells and thereby form a wall charge, is provided only at a head of a first or second subfield group at a head of the field and a first or second subfield group at a middle part of the field.

13. The plasma display panel drive method of claim 1, wherein
an initialization step of applying an initialization pulse to cause an initialization discharge in all of the cells at once and thereby form a wall charge, is provided in a head subfield of the first subfield group.

14. The plasma display panel drive method of claim 1, wherein
an initialization step of applying an initialization pulse to cause an initialization discharge in all of the cells at once and thereby form a wall charge, is provided in head subfields of first and second subfield groups.

15. The plasma display panel drive method of claim 11, wherein
the initialization discharge is performed in the initialization step in a first subfield group only when a subfield group immediately preceding the first subfield group is not a second subfield group.

16. The plasma display panel drive method of claim 1, wherein an initialization step of applying an initialization pulse is provided in all of the subfields of each second subfield group.

17. A plasma display panel drive device which uses the plasma display panel drive method described in claim 1.

18. The plasma display panel drive method of claim 6, wherein an initialization step of applying an initialization pulse to cause an initialization discharge in all of the cells at once and thereby form the wall charge is provided in each subfield that immediately succeeds a subfield in which erase is performed.

19. The plasma display panel drive method of claim 7, wherein an initialization step of applying an initialization pulse to cause an initialization discharge in all of the cells at once and thereby form the wall charge is provided in each subfield that immediately succeeds a subfield in which erase is performed.

20. The plasma display panel drive method of claim 12, wherein the initialization discharge is performed in the initialization step in a first subfield group only when a subfield group immediately preceding the first subfield group is not a second subfield group.

21. The plasma display panel drive method of claim 13, wherein the initialization discharge is performed in the initialization step in a first subfield group only when a subfield group immediately preceding the first subfield group is not a second subfield group.

22. The plasma display panel drive method of claim 14, wherein the initialization discharge is performed in the initialization step in a first subfield group only when a subfield group immediately preceding the first subfield group is not a second subfield group.

23. The plasma display panel drive method of claim 2, wherein an initialization step of applying an initialization pulse is provided in all of the subfields of each second subfield group.

24. The plasma display panel drive method of claim 3, wherein an initialization step of applying an initialization pulse is provided in all of the subfields of each second subfield group.

25. The plasma display panel drive method of claim 4, wherein an initialization step of applying an initialization pulse is provided in all of the subfields of each second subfield group.

26. The plasma display panel drive method of claim 5, wherein an initialization step of applying an initialization pulse is provided in all of the subfields of each second subfield group.

27. The plasma display panel drive method of claim 6, wherein an initialization step of applying an initialization pulse is provided in all of the subfields of each second subfield group.

28. The plasma display panel drive method of claim 7, wherein an initialization step of applying an initialization pulse is provided in all of the subfields of each second subfield group.

29. A plasma display panel drive device which uses the plasma display panel drive method described in claim 2.

30. A plasma display panel drive device which uses the plasma display panel drive method described in claim 3.

31. A plasma display panel drive device which uses the plasma display panel drive method described in claim 4.

32. A plasma display panel drive device which uses the plasma display panel drive method described in claim 5.

33. A plasma display panel drive device which uses the plasma display panel drive method described in claim 6.

34. A plasma display panel drive device which uses the plasma display panel drive method described in claim 7.

35. A plasma display panel drive device which uses the plasma display panel drive method described in claim 8.

36. A plasma display panel drive device which uses the plasma display panel drive method described in claim 9.

37. A plasma display panel drive device which uses the plasma display panel drive method described in claim 11.

38. A plasma display panel drive device which uses the plasma display panel drive method described in claim 12.

39. A plasma display panel drive device which uses the plasma display panel drive method described in claim 13.

40. A plasma display panel drive device which uses the plasma display panel drive method described in claim 14.
